(19) United States
(12) Patent Application Publication
(10) Pub. No.: US 2026/0340780 A1
(43) Pub. Date: Oct. 29, 2026

(54) CAMERA IMAGE RESTORATION AND OBJECT DETECTION USING A TRANSFORMATIVE FILTERING NETWORK

(71) Applicant: University of Washington, Seattle, WA (US)

(72) Inventors: Yan Shi, Seattle, WA (US); Chenxi Liu, Salt Lake City, UT (US); Yinhai Wang, Medina, WA (US)

(21) Appl. No.: 19/655,531

(22) Filed: Apr. 22, 2026

Related U.S. Application Data
(60) Provisional application No. 63/793,516, filed on Apr. 23, 2025.

(51) Int. Cl. G06T 5/60; G06T 5/73; G06V 20/54; G08G 1/04; G08G 1/048

(52) U.S. Cl. CPC G06T 5/60; G06T 5/73; G06V 20/54; G08G 1/04; G08G 1/048; G06T 2207/20081; G06T 2207/20084

(57) ABSTRACT

Techniques are provided herein for methods, systems, and devices for processing images captured in low-light environments. The method includes accessing a first image of a scene, the first image having a first level of degradation corresponding to a condition present when the image was captured. The first image is provided as input to a transformative filtering network, which has been trained using a hybrid dataset comprising synthetic images and simulated real-world image pairs. The method receives as output from the transformative filtering network a second image corresponding to the first image, where the second image has a second level of degradation that is less than the first. An object present in the scene is detected based at least in part on the second image. The system uses an attention-guided restoration framework to address non-uniform lens-adherent distortions and enable downstream detection.

### CROSS-REFERENCES TO RELATED APPLICATIONS

This application claims the benefit of U.S. Provisional Application No. 63/793,516 filed Apr. 23, 2025, the entire contents of which are hereby incorporated for all purposes in their entirety.

### GOVERNMENT LICENSE RIGHTS

This invention was made with government support under Grant No. 69A3552348310 awarded by the US Department of Transportation. The government has certain rights in the invention.

### TECHNICAL FIELD

The technical field of the present disclosure relates generally to image enhancement, and more specifically towards image enhancement accounting for degradation in dark settings.

### BACKGROUND

The use of cameras for object identification has become common, ranging from autonomous vehicles and surveillance systems to medical imaging and industrial automation. However, challenges arise when contaminants accumulate on camera lenses, which may impair an ability to capture clear and accurate images.

### BRIEF DESCRIPTION OF THE FIGURES

FIG. 1 depicts example degradations experienced by an illustrative camera system, according to various embodiments.

FIG. 2 depicts an illustrative system diagram for a computer system that corrects degradations experienced by an illustrative camera system, according to various embodiments.

FIG. 3 depicts an illustrative block diagram for various models used for cleaning degraded images using a computer system, according to various embodiments.

FIG. 4 depicts example attention maps generated by illustrative generators, according to various embodiments.

FIG. 5 depicts example degradations and clean images produced by an illustrative computer system, according to various embodiments.

FIG. 6 depicts example degradations and clean images produced by an illustrative computer system, according to various embodiments.

FIG. 7 depicts example nighttime images including illustrative degradations, according to various embodiments.

FIG. 8 depicts a grid of example images demonstrating differences in model methods based on a series of input images, according to various embodiments.

FIG. 9 depicts an example comparison of restoration results for models trained on a synthetic dataset, a real-world simulation dataset, and hybrid datasets, according to various embodiments.

FIG. 10 depicts an example nighttime traffic scene detected by a model showing both ground truth and detection bounding boxes including an intersection area, according to various embodiments.

FIG. 11 is a simplified diagram of an example method for detecting an object in a scene using a transformative filtering network, according to various embodiments.

FIG. 12 is a simplified diagram of an example method for detecting an object in a scene using a transformative filtering network trained with a hybrid dataset, according to some embodiments.

FIG. 13 depicts an example block diagram for an illustrative system architecture diagram for detecting objects present in scenes, according to various embodiments.

### DETAILED DESCRIPTION

Embodiments of the disclosure herein relate to methods and systems for restoring the clarity of images that have been captured by cameras with lenses affected by contaminants such as dust, water droplets, dirt, or other obstructions. The method may use a transformative filtering network, which may be a computer program trained to recognize patterns and make predictions based on data. For example, the transformative filtering network may be specifically trained to recognize and correct visual distortions in images caused by these contaminants. The method may involve creating a specialized dataset for training the transformative filtering network, combining images that have been artificially degraded using computer-generated stains, blurs, and glare, with images captured from real scenes where contaminants have been physically applied to camera lenses. The transformative filtering network may use this dataset to learn how to process a degraded image and produce a version of the image with improved clarity, reducing the effects of the contaminants. A further step may involve detecting objects, such as vehicles, in the restored image, which may be particularly useful for traffic monitoring or other surveillance applications.

Conventional methods and devices often struggle with restoring images where the camera lens has been contaminated. Many of these conventional methods focus on correcting visibility loss caused by atmospheric conditions such as fog, rain, or haze, which affect the air between the camera and the scene. These methods typically rely on algorithms designed to enhance contrast or brightness, or use physical models that estimate and correct for atmospheric effects. However, conventional methods are not well suited for correcting distortions introduced directly by stains or debris on the camera lens, especially when those contaminants are irregularly shaped, non-uniform, or semi-transparent. Conventional methods may also assume that image degradation is evenly distributed across the entire image, an assumption that does not hold for most lens contamination scenarios, which tend to produce highly localized and unpredictable distortions. Nighttime images add additional complexity, as external light sources such as vehicle headlights and streetlights may interact with the contaminants on the lens to create glare, reflections, and further loss of detail. Conventional methods also frequently require large sets of paired images (e.g., one clean and one degraded of the same scene) for training, which are difficult to obtain in real-world environments like highways at night due to the challenges of aligning images, controlling lighting, and managing moving objects.

Devices and methods that rely on physical cleaning or maintenance of camera lenses, such as wipers or cleaning fluids, present logistical challenges and may benefit from frequent intervention, which is not always feasible for cameras installed in remote or hazardous locations. Other conventional methods that use handcrafted features or simple filters tend to fail when faced with complex or non-uniform contamination patterns. In addition, many conventional machine learning methods have not been trained on datasets that accurately represent the unique distortions caused by lens contamination at night, leading to poor performance when deployed in real-world conditions.

According to embodiments described herein, systems and methods may access a first image of a scene, where the first image has a first level of degradation caused by a condition (e.g., dust buildup). The method provides the first image as input to a transformative filtering network, where the transformative filtering network has been trained using a hybrid dataset that includes a set of synthetic images and a corresponding set of simulated real-world image pairs. The synthetic images are created by applying computer-generated degradations, such as elliptical stains or Gaussian light patterns, to simulate real-world lens contamination. The simulated real-world image pairs are created by physically applying contaminants to a transparent film on a camera lens and capturing images before and after contamination. The method receives as output from the transformative filtering network a second image that corresponds to the first image and has a second level of degradation that is less than the first level of degradation. The method then detects an object present in the scene based at least in part on the second image. The transformative filtering network used in the method may include a generator with an attention block component and an autoencoder component, and a discriminator with a convolutional feature extraction component and a focused mechanism component.

For example, in a non-limiting example, a traffic agency may install surveillance cameras on a highway that are exposed to dust, rain, and other contaminants. At night, glare from vehicle headlights and streetlights may interact with dust and water droplets on the camera lens, producing blurred and partially obscured images. The method may access these degraded images captured by the camera and provide each image as input to the transformative filtering network. The transformative filtering network, having been trained on both synthetic and real-world contaminated images, may output a version of the image with improved clarity, reducing the effects of glare, dust, and stains. The method may then use object detection algorithms to identify vehicles in the restored image, supporting traffic monitoring, incident detection, or automated traffic control.

In the development of intelligent transportation systems (ITS), surveillance cameras have been widely deployed to ensure traffic safety and manage flow. However, environmental contaminants such as dust and water droplets frequently accumulate on outdoor camera lenses, leading to degraded visibility and reduced detection accuracy. Especially at night, the resulting interaction of light with lens stains further degrades image quality, thereby compromising both scene visibility and the reliability of traffic monitoring.

To address these challenges, embodiments of the present disclosure relate to an image restoration and detection framework that mitigates the effects of lens-adhering contaminants under nighttime conditions, thereby enhancing overall detection performance. The proposed framework integrates a hybrid dataset construction approach that combines synthetic data generation with real-world simulation to replicate diverse nighttime contamination scenarios. Additionally, an attention-based Generative Adversarial Network (GAN) to restore degraded images while preserving scene details may be implemented. The restored images may be subsequently processed using a detection model (e.g., YOLO) to improve object detection performance. Embodiments of the present disclosure improve nighttime traffic monitoring and ensuring more reliable ITS operations.

In some embodiments, a computer-implemented method incorporating a GAN trained as described herein, may be used for improved object detection. Such a method may include accessing a first image of a scene. The first image may include a first level of degradation corresponding to a present condition when the first image was captured. The method may also include providing the first image as input to a transformative filtering network (e.g., the GAN trained as described herein using hybrid dataset). For example, the transformative filtering network may have been trained using a hybrid dataset including a set of synthetic images and a corresponding set of simulated real-world images. The method may also include receiving as output from the transformative filtering network a second image corresponding to the first image. The second image may include a second level of degradation that is less than the first level. The method may also include detecting an object present in the scene based at least in part on the second image. Systems, apparatuses, and the like incorporating the method are also described herein.

In some embodiments, a computer-implemented method of training a transformative filtering network using synthetic data is described herein. The method may include accessing a first set of synthetic images including one or more artificially created degradations that simulate degradations real-world environment. The method may also include accessing a second set of simulated real-world images comprising one or more naturally generated degradations that are generated by the real-world environment. The first set of images may correspond to the second set of images (e.g., define a set of image pairs). The method may also include generating a hybrid dataset by combining the first set of synthetic images with the second set of simulated real-world images. The method may also include training the transformative filtering network using the hybrid dataset. Systems, apparatuses, and the like incorporating the method are also described herein.

The method described herein addresses the deficiencies of conventional devices by using a transformative filtering network that has been trained on a hybrid dataset specifically designed to include both synthetic and simulated real-world degradations. This training process allows the transformative filtering network to recognize and correct complex, irregular, and localized distortions caused by contaminants on camera lenses, even under challenging nighttime lighting conditions. The use of synthetic images allows for scalable and customizable training data generation, while the simulated real-world images ensure that the transformative filtering network learns to handle the variability and unpredictability of actual lens contamination. By outputting a second image with reduced degradation, the method enables reliable object detection and scene analysis without physical cleaning or maintenance of the camera lens.

Technical advantages of this method may include the ability to restore image clarity in the presence of non-uniform, semi-transparent, and irregular contaminants that affect only portions of the image, which is not possible with many conventional approaches. The method may also reduce frequent physical maintenance of camera installations, as the method addresses visual degradation through software processing rather than mechanical cleaning. The hybrid training dataset improves the generalization of the transformative filtering network, allowing the method to perform well under diverse real-world conditions, including varying lighting, contamination patterns, and scene types. The method may be implemented on edge devices, allowing real-time processing without, in some embodiments, cloud-based computation, supporting low-latency applications such as automated traffic control.

Although methods and systems are described herein in the context of traffic surveillance, the methods and systems may be applicable in a range of other industries. For example, the method may be used in security surveillance, industrial inspection, medical imaging, agricultural monitoring, and any setting where cameras are exposed to environmental contamination that may degrade image quality. These examples are not limiting, and the method may be applied wherever restoration of images degraded by lens contamination is desirable.

In addition, the degradation addressed in this disclosure may occur not only directly on the lens of the camera, but also on any protective layer or component that is positioned in front of the lens. Many devices use shields, external coatings, glass covers, or additional transparent layers that serve to protect the actual lens from the environment. The presence of dust, water droplets, stains, or similar substances on these elements may similarly impair image quality by introducing blur, glare, distortion, or reduced visibility in the captured image. The method described herein may be applied regardless of whether the degradation is located on the lens itself or on any intervening transparent layer, shield, coating, or glass component that is positioned between the scene and the imaging sensor. This flexibility allows for the restoration of images degraded by a variety of real-world scenarios where any transparent protective structure accumulates contaminants that negatively impact image clarity.

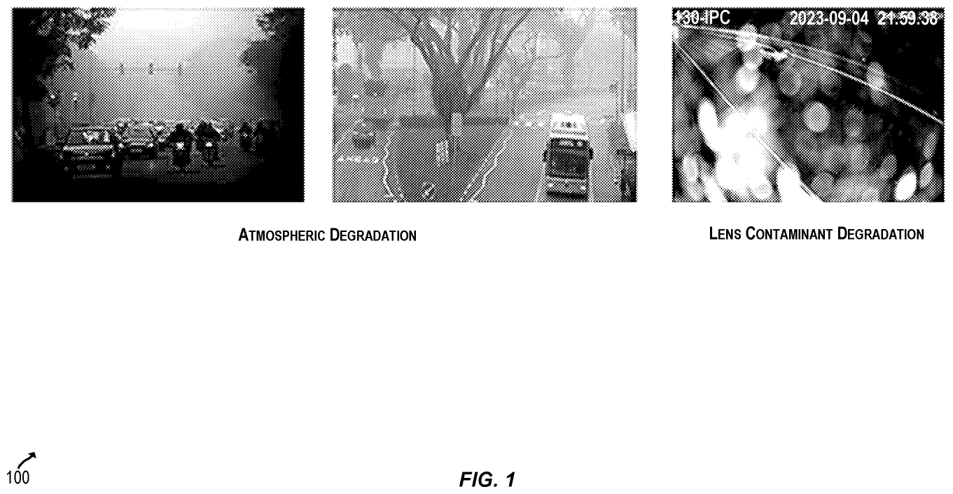

FIG. 1 depicts example degradations experienced by an illustrative camera system 100, according to various embodiments. By way of a non-limiting example, a camera system may be positioned in an outdoor environment as part of an intelligent transportation system that monitors traffic flow and vehicle activity. In such a scenario, the camera system may be subject to environmental factors that cause image quality to deteriorate over time.

Camera systems often encounter the accumulation of contaminants such as dust, dirt, water droplets, snow, or other substances on optical surfaces. These substances may adhere to the lens or to any shield, coating, or transparent cover that protects the lens. As a result, the clarity and visibility of images captured by the camera system may be reduced. This degradation may be particularly problematic during nighttime operation, when low ambient light and artificial illumination from vehicle headlights or streetlights interact with the contaminants and further diminish image quality. For example, glare, reflections, and non-uniform blur may become prominent, complicating the ability of the camera system to reliably detect and classify objects in the scene.

Manual cleaning of the lens or protective surface may be a possible remedial measure; however, this method often presents significant logistical and safety challenges. Regular maintenance may require specialized equipment and trained personnel, and in many environments, contaminants can quickly redeposit on the surface, resulting in recurring image degradation. As a result, the effectiveness and reliability of traffic monitoring and safety operations may be compromised, especially when consistent image quality is desired for tasks such as vehicle detection, image classification, or incident response.

As previously discussed, conventional image restoration techniques have typically focused on correcting atmospheric distortions such as fog, haze, or rain that affect visibility in the air between the camera and the scene (as illustrated in the left portion of FIG. 1). However, these methods may be insufficient when addressing degradations that occur on the optical surfaces of the camera system (as depicted in the right portion of FIG. 1). Unlike atmospheric effects, stains and obstructions on the lens or protective layers create a secondary optical layer. This results in irregular, unpredictable patterns of blur, distortion, and light scattering. These effects are often more pronounced in nighttime conditions, where the presence of strong artificial lighting sources (e.g., headlights) interacts with the contaminants, producing glare and further reducing the camera system's ability to produce clear images.

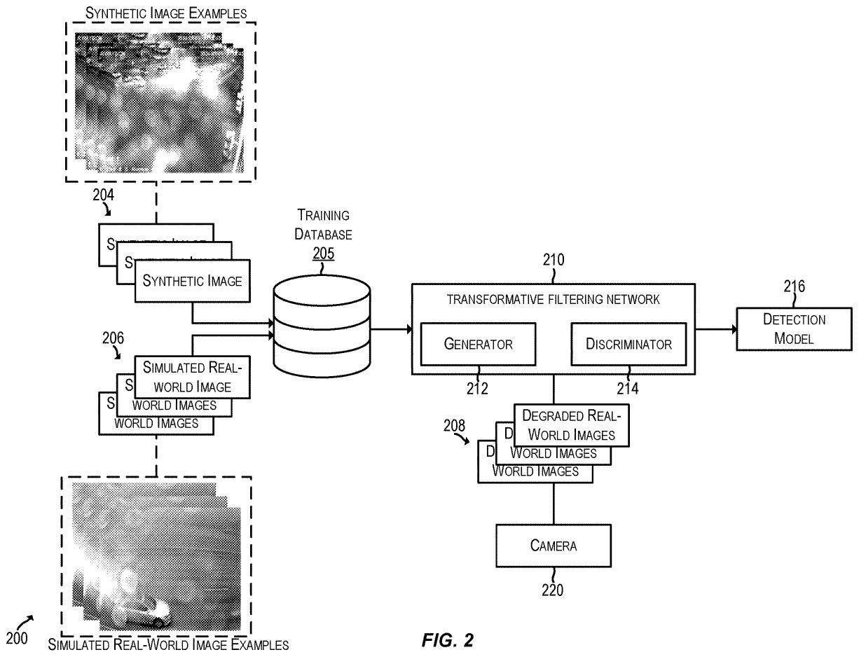

FIG. 2 depicts an illustrative system diagram for a computer system 200 that corrects degradations experienced by an illustrative camera system, according to various embodiments. By way of a non-limiting example, the computer system 200 may integrate dataset construction, image restoration, and object detection. A hybrid dataset can be constructed using both synthetic images 204 and simulated real-world images 206. Using both synthetic images 204 and simulated real-world images 206 replicates common nighttime degradation effects, including stains, glare, and variable lighting conditions so a comprehensive representation of real-world scenarios may be obtained. To restore image quality, a model (e.g., attention-guided restoration network) may selectively enhance affected regions to effectively correct distortions and/or degradations. For purposes of this disclosure, the terms “distortion” and “degradation” may be used interchangeably to refer to any condition that reduces the clarity, quality, or visibility of an image. In some embodiments, the model may concentrate on areas with the most severe degradation. The model may preserve overall image integrity while mitigating non-uniform distortions. The restored images may be processed by a detection model, (e.g., YOLOv8) for object detection, which may improve recognition performance in dust-degraded conditions. In some embodiments, the model can be replaced with object detectors (e.g., hardware, software) to improve an adaptability of the computer system 200 across various surveillance applications.

A hybrid dataset, as used throughout this disclosure, may include a collection of image data that combines both synthetic images and simulated real-world images to support training and evaluation of transformative filtering networks. The synthetic images may be generated by applying algorithmic degradations, such as simulated stains, blurs, glare, and light scattering, to clean base images to mimic a range of visual impairments that may occur in real-world environments. Simulated real-world images may be acquired by physically introducing contaminants, such as dust or water droplets, onto a transparent film or directly onto a camera lens, and capturing corresponding image pairs before and after the application of these substances under controlled conditions. Blending degraded synthetic images with paired clean and contaminated real-world images, the hybrid dataset may enable a transformative filtering network to learn a variety of degradation patterns and restoration challenges than would be possible using only synthetic or only real-world data alone.

In some embodiments, the hybrid dataset may include any arrangement where both synthetic images and real or simulated real-world images are utilized during the training of a transformative filtering network. The synthetic and real images may be combined into a single dataset prior to training, or they may be used separately, for example, by interleaving synthetic and real images within each training batch, or by conducting training in discrete phases where the transformative filtering network is first trained on one type of image and subsequently on the other. The hybrid dataset may also encompass scenarios where the transformative filtering network parameters are pre-trained on synthetic images and then fine-tuned using real or simulated real-world images, or where different subsets of the dataset are presented to the transformative filtering network based on changing environmental conditions, application parameters, or iterative training schedules. Thus, the use of the term “hybrid dataset” is intended to cover any suitable method or strategy in which both synthetic and real or simulated real-world images are included in the training process, whether as a merged, alternated, or phase-based set, and is not limited to a singular, physically combined dataset.

The computer system 200 may integrate data construction, image restoration, and detection to mitigate nighttime image degradation from lens-adhering contaminants. In some examples, the computer system 200 may improve precision compared to convention systems (e.g., an improvement of greater than 90% precision and 85.0% mean average precision at 50% IoU (mAP50)) for object detection. Additionally, the computer system 200 may integrate and or be deployed (e.g. retrofit, software update, firmware update, etc.) with existing surveillance systems, improving resilience and reliability under adverse conditions.

In various embodiments, an attention-guided Generative Adversarial Network (GAN) may be used that focuses on degraded regions, using adversarial training to generate realistic reconstructions. For example, the GAN may recover content obscured by stains but also preserves details, ensuring consistent image quality for downstream detection tasks.

By way of a non-limiting example, the computer system 200 may include a training database 205 that stores at least synthetic images 204 and simulated real-world images 206. The synthetic images 204 may be generated by programmatically simulating degradations that are likely to occur in real-world nighttime surveillance scenarios. For example, synthetic images 204 may be created by applying elliptical masks to clean images (e.g., undegraded) to simulate the effect of dust, dirt, or water droplets that accumulate on a camera lens of a camera 220. In some cases, each ellipse may be defined by parameters such as center coordinates, major and minor axis lengths, and orientation, with randomization of these parameters to mimic the irregular placement and size distribution of stains. Additionally, transparency values for each elliptical mask may be randomly selected to reflect varying levels of opacity or thickness of contaminants. These elliptical masks may be layered over original scene images, and different blends of transparency may be used to replicate realistic occlusion patterns.

In some embodiments, synthetic images 204 may be generated using a variety of computer-based techniques that simulate the visual effects of lens contamination, daytime conditions, and/or nighttime lighting conditions. For example, degradations may be applied to base images using graphical overlays, algorithmic transformations, or a combination of both. An example technique may involve generating masks with random shapes (e.g., ellipses, polygons, freeform contours) that represent dust, dirt, water droplets, or smudges. These masks may be layered onto clean images with variable opacity, color channels, and edge softness to simulate stains with different levels of transparency, thickness, or sharpness. The masks may be further randomized in terms of location, orientation, scale, and density to introduce non-uniform and spatially variant contamination patterns. In addition, fractal noise, Perlin noise, or procedural textures may be used to create complex, irregular stain shapes and distributions that more closely resemble real-world contaminants.

To simulate glare and light scattering effects commonly encountered at night, the synthetic images 204 may be augmented by overlaying Gaussian blobs, radial gradients, or point spread functions. These elements may model the way headlights, streetlights, or reflective surfaces interact with contaminants to produce halos, flares, or bloom. The intensity, size, color, and position of each light artifact may be algorithmically varied for each image to capture a wide range of realistic lighting scenarios. Other suitable techniques may include, without limitation, simulating camera motion blur by applying directional or radial blur filters, or introducing defocus blur to mimic the effects of condensation or oily films on the lens.

Further, degradations may be applied using pixel-wise operations such as adding random noise, adjusting local contrast, or shifting color balance to simulate sensor artifacts or chromatic aberrations induced by contaminants. Synthetic rain, fog, or snow effects may also be layered onto images using procedural or particle-based generation, either as isolated overlays or in combination with lens stains to replicate complex environmental conditions. In some cases, computer vision or graphics engines may be used to synthesize entire scenes with controllable weather, lighting, and contamination parameters, creating images where the ground truth is precisely known.

In some embodiments, the condition resulting in image degradation may include a combination of two or more factors present in the scene at the time an image is captured. For instance, a single image may simultaneously exhibit effects from dust accumulation, water droplets, and smudges on the lens, as well as atmospheric conditions such as fog or rain, or may include the presence of glare, reflection, and motion blur. These multiple conditions may overlap, interact, or manifest in different regions of the image, giving rise to complex, spatially varying patterns of degradation. Accordingly, the synthetic images 204 or simulated real-world images 206 may be generated or selected such that several types of contamination or distortion are present within a single image, ensuring that the resulting dataset includes examples where multiple degradation mechanisms are concurrently observed.

In certain embodiments, the process of generating synthetic images 204 may be automated using scripts, batch processing tools, or dedicated simulation software. The generation may support the creation of paired datasets, where each clean image is programmatically degraded to produce a corresponding contaminated version, or unpaired datasets, where degradations are applied independently to a set of images drawn from a broader collection. Synthetic images 204 may be created from photographs, rendered scenes, or a combination of both, depending on preferences.

Throughout the disclosure, references are made to both synthetic images, which are artificially degraded using computational models, and simulated real-world images, which are captured by physically introducing contaminants onto cameras under controlled conditions. These images are discussed in the context of dataset generation, model training, and validation, with multiple figures and portions of the specification illustrating their creation, characteristics, and use within the disclosed system. In particular, this disclosure describes the formation of image pairs by aligning each clean image with a corresponding degraded image, whether generated synthetically or through real-world simulation. For example, these image pairs maybe used as a framework for supervised learning so that the transformative filtering network may learn the mapping between degraded and clean visual representations. The existence of paired images allows the model to directly compare the features present in both the contaminated and uncontaminated versions of the same scene, facilitating more precise restoration of affected regions while preserving scene details that remain unchanged. The use of aligned pairs also supports evaluation of model performance by providing a clear reference for quantifying improvements in clarity, feature recovery, and detection accuracy.

The synthetic images 204 may be constructed by leveraging Gaussian distributions to simulate the interaction of vehicle headlights with lens stains, thereby reproducing the visual degradation commonly observed in nighttime surveillance. The dataset generation may involve two or more stages. First, simulate the spatial distribution of stains, which predominantly take on elliptical shapes. Specifically, each stain is generated using an ellipse defined by:

$$\frac{x - {{x}_{c}}^{2}}{a} + \frac{y - {{y}_{c}}^{2}}{b} = 1$$

where (x_{c}, y_{c}) are the coordinates of the ellipse's center, and a and b are the lengths of the major and minor axes, respectively. Each stain's transparency is regulated by a random alpha value α, which simulates varying accumulations of dust and particles on the lens surface. The final stained image is generated by superimposing the elliptical stains onto the original grayscale image via the weighted sum:

I_{stained}=α·I_{overlay}+(1−α)·I_{original}

where I_{stained} is the resulting image with stains, I_{overlay} contains the elliptical stains, and I_{original} is the clean background image. In the second stage, Gaussian blobs are generated to represent dust particles scattering light, an effect that becomes more intense at night. A Gaussian blob is defined by:

$$G ( x , y ) = I * {e}^{- \frac{{( x - {x}_{c} )}^{2}}{2 {σ}^{2}} + \frac{{( y - {y}_{c} )}^{2}}{2 {σ}^{2}}}$$

where G(x, y) is the intensity of the Gaussian blob at point (x, y), I is the maximum intensity of the blob, (x_{c}, y_{c}) are the coordinates of the blob's center, and σ is the standard deviation determining the spread of the blob. A mesh grid may be created over the image and compute these functions for random centers and radii. The resulting blobs are normalized and combined with the stained image according to:

$${I}_{blobs} ( x , y ) = {\sum }_{i = 1}^{N} {G}_{i} ( x , y )$$

I_{final}=β·I_{blobs}+(1−β)·I_{stained}

where N is the number of Gaussian blobs, Gᵢ(x, y) is the ith Gaussian blob, and β controls the blending intensity. Through this two-step process elliptical stains followed by Gaussian blobs, both the occlusion and uneven brightness commonly encountered in nighttime highway images may be replicated.

Using the previous method, Gaussian light blobs, Gi(x, y), may be overlaid onto the images to model the scattering of headlights or streetlights by dust particles on the lens. Each Gaussian blob may be defined by a center point, a maximum intensity, and a standard deviation controlling the spread of the blob. The placement, number, and intensity of these blobs may be randomized for each image, creating a dataset that includes diverse lighting artifacts such as glare, bloom, and uneven brightness. For example, one synthetic image 204 may feature multiple overlapping Gaussian blobs to replicate the effect of several vehicle headlights shining directly into the camera 220, while another may have a single, faint blob to represent distant illumination. The synthetic dataset may be further expanded by varying the underlying clean scenes, such as different road types, vehicle positions, and ambient lighting conditions.

Simulated real-world images 206 may be generated by physically replicating degradation effects under controlled conditions. In an example, a transparent film may be affixed to the lens of a camera 220, after which dust, water droplets, or a combination of contaminants may be applied to the film. The camera 220 may then capture images of a traffic scene in both the unstained (clean) state and the stained (degraded) state, ensuring that each pair of images is aligned in terms of viewpoint and lighting. The process may be repeated with different types and concentrations of contaminants, varying the size, distribution, and transparency of stains. For example, some simulated real-world images 206 may be captured after spraying a fine mist of water (e.g., clean or dirty) to create small, nearly transparent droplets, while others may use a dusting of fine powder for a more opaque, diffuse effect. Additionally, simulated real-world images 206 may be collected under different lighting conditions, such as, but not limited to, with vehicle headlights on or off, or at various times of night, to capture a range of realistic scenarios encountered in actual traffic surveillance. This process may result in a set of paired images, where each clean image has a corresponding degraded version with known, physically applied contamination.

Simulated real-world images 206 may be generated through a variety of experimental procedures that introduce actual environmental contaminants or physical distortions to the imaging system, creating image data that closely reflects the complexities of real-world degradation encountered in operational surveillance settings. For example, a transparent film or removable substrate may be affixed to the lens or protective cover of camera 220. Onto this film, various forms of contamination may be applied, including but not limited to dust, dirt, particulate matter, water droplets, oil, smudges, fingerprints, stains, or a combination of these. Application techniques may include spraying, splattering, brushing, dripping, or depositing contaminants by hand or using controlled laboratory equipment. The composition, concentration, and distribution of contaminants may be systematically varied to produce a range of degradation patterns, such as uniform coatings, clustered particles, streaks, or random scatter. The application may occur in one or multiple layers to simulate different levels of opacity, thickness, or wetness, and in some cases, the contaminants may be partially removed or smeared to create semi-transparent or gradient effects.

To capture the effects of ambient environmental conditions on lens contamination, simulated real-world images 206 may be collected under controlled illumination. Lighting conditions may be adjusted to include low-light or nighttime environments, direct or indirect illumination, variable color temperature, or the presence of strong artificial light sources such as vehicle headlights, streetlights, or reflective signage. In addition, the scene being imaged may be varied to include different backgrounds, moving objects, or static features, allowing for the simulation of glare, reflections, and shadow artifacts that commonly occur at night.

The procedure for generating simulated real-world images 206 may include capturing a baseline image of the scene with a clean lens (i.e., prior to contamination) and then capturing one or more images after the contaminants have been applied. Care may be taken to maintain the same camera position, orientation, and exposure settings between the clean and degraded captures, so that each pair of images is aligned and comparable. In some cases, multiple image pairs may be recorded as the extent or type of contamination is progressively modified, such as increasing the density of dust, adding water droplets, or introducing new types of stains.

For examples involving dynamic contamination, the camera 220 may be exposed to real environmental conditions (e.g., placing the camera outdoors during rain, snow, or dust storms), or subjected to vibration, air flow, or temperature changes to study the accumulation and evolution of contaminants over time. The film or substrate may be periodically replaced or cleaned to allow for repeated experimentation and variation of the contamination process. Simulated real-world images 206 may also be captured with different camera hardware, lens types, sensor formats, or protective covers to account for variation in optical characteristics across devices.

To further enhance the realism of the dataset, the simulated real-world images 206 may be post-processed to correct for alignment, normalize brightness or contrast, or annotate regions of interest (e.g., areas most affected by contamination). Metadata describing the type, quantity, and application method of contaminants, as well as environmental parameters (e.g., temperature, humidity, illumination settings), may be recorded alongside each image or image pair. This process allows for the systematic collection of diverse, physically grounded examples of degradation that accurately reflect the operational challenges faced in actual nighttime traffic surveillance or similar applications.

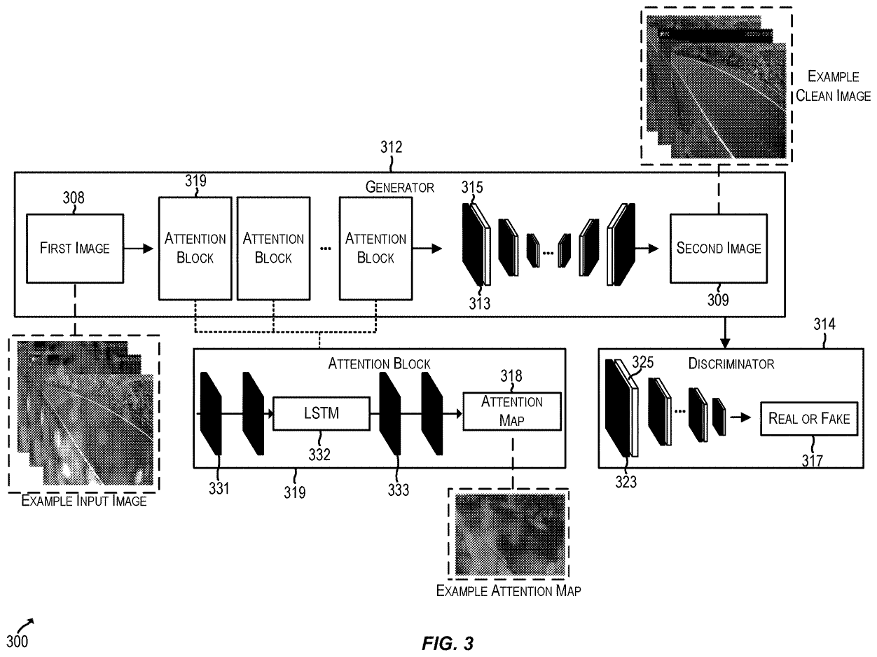

The training database 205 may store the synthetic images 204 and simulated real-world images 206 together as a hybrid dataset. This hybrid dataset may then be used to train a transformative filtering network 210. The transformative filtering network 210 may include a generator 212 and a discriminator 214. The generator 212 may be configured to receive degraded images and output restored versions that reduce or remove the effects of contamination. The discriminator 214 may evaluate an authenticity of the restored images by distinguishing them from clean images, providing feedback that guides the training of the generator 212. While the architecture and operation of the transformative filtering network 210 are more fully detailed in FIG. 3, at this stage, the transformative filtering network may rely on the hybrid dataset to learn how to map degraded inputs to cleaner outputs under a variety of simulated and physically captured conditions.

Once the transformative filtering network 210 (e.g., a GAN model, a machine learning model, etc.) has been trained using the hybrid dataset from the training database 205, the improved images output by the generator 212 may be provided to a detection model 216. The detection model 216 may identify objects of interest, such as vehicles or pedestrians, within the restored images. By receiving images that have had degradations and distortions reduced, the detection model 216 may achieve higher accuracy in object recognition, localization, and classification tasks. This may be particularly valuable in low-visibility environments where direct detection on degraded images may yield a high rate of missed or false detections. The detection model 216 may be implemented using any of a variety of object detection algorithms, such as those based on deep learning architectures, and may be further fine-tuned using the restored images produced by the transformative filtering network 210.

By way of a non-limiting example, a camera 220 may be positioned to capture images of a scene in an environment that is prone to various forms of visual degradation. The camera 220 may experience conditions such as dust, dirt, water droplets, stains, smudges, glare, fog, snow, or combinations thereof on its lens or in the scene, which cause the images captured to exhibit reduced clarity, contrast, or visibility. These visually compromised outputs, referred to as degraded real-world images 208, may exhibit non-uniform, spatially variant, or variable-intensity distortions depending on the nature and extent of the environmental contaminants or ambient lighting conditions (e.g., low light, vehicle headlights, streetlights).

Low light (e.g., low light environment) may include imaging conditions where the illumination present in the scene falls below the optimal threshold for standard imaging sensors, resulting in images that are often noisy, blurry, or lacking in detail and contrast. Quantitatively, low light is generally understood as ambient lighting at or below approximately 10 to 50 lux, with some scenarios dropping to levels below 1 lux. For context, a full moon on a clear night may provide around 0.1 to 0.3 lux, while urban street lighting may yield values between 5 and 20 lux. A typical office environment may be lit at about 300 to 500 lux, while a well-lit overcast day outdoors may exceed 1000 lux. In terms of lumens, which measure total light output from a source, low light for imaging applications may correspond to situations where the available light per unit area is significantly less than what is provided by standard indoor lighting fixtures, which may emit several hundred lumens distributed over a workspace. For example, a hallway illuminated only by emergency exit signs may be below 5 lux, whereas a warehouse corner receiving minimal spillover from distant lamps may present an environment under 1 lux. Examples of low light conditions include, without limitation, nighttime streets illuminated only by distant or shielded streetlights, vehicle interiors at night with only instrument panel lighting, rural roadways without artificial lighting, indoor rooms with lights turned off and curtains drawn, or outdoor scenes under heavy cloud cover just before dawn or after sunset.

The camera 220 may be any suitable imaging device, including but not limited to a visible spectrum camera, an infrared camera, a combined optical and infrared camera, or other sensors capable of capturing still or video imagery in traffic, surveillance, or industrial settings. Examples of scenarios where camera 220 may operate include highway surveillance, intersection monitoring, parking lot observation, or perimeter security, where adverse environmental factors frequently impair image quality.

Once the camera 220 captures one or more degraded real-world images 208, this image may be transmitted, either in real-time or as part of a batch process, to the transformative filtering network 210 for restoration. The transmission pathway may utilize wired or wireless communication protocols, depending on the deployment context and system architecture.

Degraded real-world images 208 may include one or more images (or video) acquired in operational environments where a camera 220 is exposed to conditions that lead to reduced image clarity, visibility, or fidelity due to the presence of contaminants or adverse environmental effects. In a traffic monitoring context, the camera 220 may be installed along highways, intersections, tunnels, bridges, or parking facilities, where dust, water droplets, stains, mud, glare, snow, insects, or atmospheric particulates accumulate on the lens, protective shield, or any transparent barrier. In a security or surveillance setting, camera 220 may be positioned at building perimeters, entryways, industrial sites, or critical infrastructure, where environmental factors such as rain, fog, smoke, or vandalism may introduce smears, fingerprints, scratches, or other obstructions. For medical applications, the camera 220 may be used in endoscopy, microscopy, or surgical navigation, with image degradation resulting from bodily fluids, condensation, or residue on optical windows. In laboratory or manufacturing environments, camera 220 may capture images in cleanrooms, production lines, or research chambers, with potential contaminants including chemical vapors, dust, or sample residues. In each of these scenarios, degraded real-world images 208 may exhibit spatially non-uniform, semi-transparent, or highly localized distortions that manifest as blurring, loss of contrast, occlusion, scattering, or color imbalance. These images may be single frames or part of a continuous video stream and may be transmitted in real time or stored for post-processing. The diversity of deployment contexts ensures that degraded real-world images 208 encompass a spectrum of visual challenges that reflect the operational realities faced across different industries.

The transformative filtering network 210 may be trained to process degraded real-world images 208 and produce a corresponding “cleaned” image that exhibits reduced distortion or degradation. The transformative filtering network 210 may have been trained using a hybrid dataset contained in the training database 205. The hybrid dataset may include synthetic images 204 and simulated real-world images 206. Synthetic images 204 may be generated by applying simulated degradations to clean images.

After the transformative filtering network 210 processes the degraded real-world image 208, the restored image may be provided to the detection model 216. The detection model 216 may identify, locate, or classify objects of interest in the scene, such as vehicles, pedestrians, obstacles, or any suitable objects or patterns (e.g., direction of travel). Detection model 216 may utilize object detection architectures such as YOLO, Faster R-CNN, or any other suitable detection algorithm. The improved clarity and feature preservation in the restored image may enable detection model 216 to achieve higher accuracy in object recognition and localization tasks than would be possible on the degraded real-world image 208 alone.

In various embodiments, operations of a camera that may be controlled based at least in part on detecting an object present in the scene. These operations may be varied and may include, but are not limited to, dynamically adjusting the camera's field of view, zoom level, focus, exposure, aperture, and shutter speed in response to real-time detection results. For example, upon identifying a vehicle or pedestrian in a restored image, the system may command the camera to zoom in or pan to maintain the object within the center of the frame or to track its motion across multiple frames. The camera may automatically refocus to sharpen the image of a newly detected object or adjust exposure settings to compensate for changing ambient light conditions such as oncoming headlights or shifting street illumination. Additional operations may include, without limitation, toggling between day and night modes, switching between visible and infrared imaging, initiating high-resolution still captures in response to specific detection events, or activating supplemental lighting such as infrared LEDs to enhance image clarity during low-light or nighttime conditions. The system may further command the camera to begin or cease continuous recording, initiate burst image capture, or tag and archive video segments associated with detected objects for later review. In some embodiments, the camera may be directed to communicate with other networked devices, such as sending an alert to a control center when certain types of objects (e.g., emergency vehicles, bicycles, or animals) are identified or when abnormal conditions, such as stopped vehicles or objects in restricted zones, are detected. The system may also adjust camera parameters in anticipation of recurring events, such as scheduled traffic surges or known periods of reduced visibility, based on historical detection patterns.

In various embodiments, operations of a traffic system may be controlled based at least in part on detecting an object present in the scene and may encompass a range of functions relevant to intelligent transportation systems and urban infrastructure management. Such operations may include, without limitation, triggering adaptive traffic signal control based on detected vehicle queues or pedestrian presence, activating or deactivating dynamic lane assignments, and adjusting variable message signs to inform drivers of hazards, congestion, or incidents detected through restored imagery. For example, when a vehicle is detected traveling in the wrong direction or stalled on a roadway, the system may automatically command the traffic management infrastructure to highlight warnings on roadside displays, modify signal timing to facilitate emergency response, or reroute traffic to alternate routes. Additional operations may involve controlling ramp meters, opening or closing lanes in managed lane scenarios, and activating automated barrier systems in response to the detection of maintenance vehicles, emergency responders, or unauthorized access. The traffic system may also generate real-time incident alerts to connected vehicles or public safety agencies, initiate automated toll collection adjustments (with appropriate user permissions) based on detected vehicle classifications, or trigger environmental controls such as activating fog lights, de-icing systems, or ventilation in tunnels upon identifying specific weather-related obstructions or traffic density thresholds. In some embodiments, the system may further support multimodal operations, such as prioritizing transit signal priority for detected buses or trams, adjusting pedestrian crossing phases when groups of pedestrians are identified, or integrating with smart parking systems to update availability based on detected vehicle occupancy.

In various embodiments, the operations for controlling the camera may include adjusting camera orientation or pan-tilt-zoom parameters to track a detected person of interest across different areas of a facility, or initiate autofocus and exposure compensation when sudden changes in ambient lighting are detected, such as when a door opens or a light is switched on. In industrial inspection, the camera may be controlled to periodically recalibrate its lens or activate a lens-cleaning mechanism when visual degradation is detected, such as dust or oil residues accumulating on the optical surface. In medical imaging applications, the system may direct the camera to adjust white balance, gain, or shutter speed to compensate for varying tissue reflectivity or the presence of fluids during endoscopic procedures, or trigger a high-resolution capture mode when a region of interest is identified by the transformative filtering network. In agricultural monitoring, the camera may be repositioned or its field of view altered to focus on specific crops or sections of a greenhouse where plant stress or disease symptoms are detected, or may alternate between different imaging modalities such as visible light, infrared, or hyperspectral channels based on the type of analysis required. Additional operations may include initiating a sequence of time-lapse captures to monitor progressive changes, toggling between still image and video recording modes in response to detected activity, activating or deactivating on-board illumination sources such as LEDs, or transmitting alerts to remote operators when persistent image degradation suggests the need for manual intervention.

Image restoration in adverse weather conditions is important for maintaining the effectiveness of traffic surveillance cameras. Environmental factors like rain, fog, snow, and dust degrade image quality, compromising safety monitoring and incident recording systems. For example, adverse weather affects images in at least two ways: (1) atmospheric pollutants (e.g., rain, fog, snow) reduce visibility or obscure scenes (illustrated with respect to FIG. 1, left), and (2) lens-adhering contaminants (e.g., droplets, dust, stains) create a “secondary lens”, introducing blur and distortion (illustrated with respect to FIG. 1, right).

Training an image restoration model requires paired stained and clean images, yet collecting such data in highway environments poses unique difficulties. Vehicle headlights, road lights, and various forms of lens contamination interact to drastically reduce image clarity, and no suitable open-source datasets currently address these combined challenges. To address this gap, we construct two types of datasets. The first is a synthetic dataset, where we simulate elliptical stains and Gaussian blobs to mimic nighttime lens contamination. The second is a real-world simulation dataset, generated by applying a thin transparent film to camera lenses and spraying it with dust and water droplets under controlled nighttime settings. These complementary datasets provide diversity and realism for robust model training and evaluation.

Deployment of the transformative filtering network 210 to another edge device, or to multiple connected edge devices over a network, may be accomplished by transmitting the trained model parameters, configuration files, and necessary execution instructions from a central controller or repository to the targeted edge hardware. For example, as discussed with reference to FIG. 2, a traffic management system may distribute the attention-guided restoration and detection model to roadside surveillance cameras, vehicle-mounted cameras, or other sensor platforms operating at the network edge. These edge devices may be physically distributed across a highway corridor, at urban intersections, or along critical infrastructure, and may be interconnected through wired Ethernet, wireless mesh, cellular, or dedicated short-range communication (DSRC) protocols. Once deployed, each edge device may independently execute the model for real-time restoration and object detection on locally captured images, thereby enabling low-latency decision-making and reducing the bandwidth required to transmit high-resolution image data to a central server. In addition, deployment may be managed dynamically, with model updates, retraining results, or new configuration settings securely pushed to edge devices in response to evolving environmental conditions or operational requirements.

FIG. 3 depicts an illustrative block diagram for various models used for cleaning degraded images using a computer system 300, according to various embodiments. The computer system 300 may implement a transformative filtering network (which is an example of the transformative filtering network 210 with respect to FIG. 2) that may process a first image 308 of a scene and generate a second image 309 with reduced degradation. The first image 308 may be any image that exhibits visual degradation due to factors such as dust, stains, glare, or other obstructions. The transformative filtering network may include a generator 312 may receive the first image 308 and apply one or more attention blocks 319. Each attention block 319 may be designed to focus computational resources on regions of the first image 308 that are most affected by degradation, improving the restoration of details.

Within each attention block 319, one or more residual blocks 331 may be used to process the first image 308. Residual blocks 331 may be implemented as modular neural network subunits that facilitate the learning of both low-level and high-level image features, while allowing the model to maintain information across multiple layers. For example, a residual block 331 may include a sequence of convolution layers that extract features such as edges, textures, or patterns, followed by normalization and non-linear activation functions (e.g., ReLU, Leaky ReLU). The output of these layers may be combined with the original input to the block using a skip connection, which helps to address issues related to vanishing gradients and enables the model to learn both identity mappings and complex transformations. In the context of image restoration, residual blocks 331 may be used to highlight and correct localized distortions, remove blurring, and restore sharpness or contrast in regions affected by contaminants. In some embodiments, multiple residual blocks 331 may be stacked to increase the representational capacity of the attention block 319, allowing for the correction of degradations.

The attention block 319 may also include a Long Short-Term Memory (LSTM) component 332, which is designed to capture temporal or sequential dependencies in the feature representations generated by the residual blocks 331. The LSTM 332 may be particularly useful when processing sequences of images (e.g., video frames) or when modeling long-range spatial dependencies within a single image. The LSTM 332 may iteratively refine its focus on different regions of the first image 308 by updating internal gating mechanisms (e.g., input, forget, and output gates), which control the flow of information based on the current input and previous hidden states. For example, the LSTM 332 may direct attention to areas exhibiting blur, glare, or occlusion, ensuring that these regions receive prioritized processing in subsequent layers. The output of the LSTM 332 may be provided to one or more convolution layers 333, which generate an attention map 318 indicating the spatial locations within the image that require the most restoration.

The attention map 318 produced by the attention blocks 319 may be used to guide further processing of the first image 308. The attention map 318 may be provided to one or more convolution layers 313 that apply learned filters to enhance or reconstruct the identified regions, followed by one or more Rectified Linear Unit (ReLU) layers 315 that introduce non-linearity and help in modeling complex relationships between input features and target outputs. The combination of these layers may yield a second image 309, which exhibits reduced degradation relative to the first image 308. The second image 309 may exhibit improved clarity, contrast, and feature visibility, supporting subsequent object detection or scene analysis tasks.

Following generation, the second image 309 may be evaluated by a discriminator 314, which serves to distinguish between restored images generated by the model and authentic clean images. The discriminator 314 may include one or more convolution layers 323, which extract hierarchical features from the second image 309, and one or more ReLU layers 325, which introduce non-linear decision boundaries. The discriminator 314 may output a classification (e.g., real or fake 317) indicating whether the second image 309 is likely to be a genuine clean image or a restored image produced by the generator 312. This adversarial feedback may be used during training to improve the quality and realism of the restored images, driving the generator 312 to produce outputs that are increasingly indistinguishable from true clean images.

Examples of operations within the residual blocks 331 include edge enhancement, deblurring, noise reduction, and contrast adjustment, each implemented using a combination of convolution, normalization, and activation layers. The LSTM 332 may be trained to recognize patterns of degradation that exhibit temporal or spatial coherence, such as the spread of glare across adjacent pixels or the consistent shape of dust particles across multiple frames. Convolution layers 333, 313, and 323 may utilize kernels of varying sizes and dilation rates to capture both fine details and broader contextual information. ReLU layers 315 and 325 may be interleaved with normalization techniques (e.g., batch normalization, instance normalization) to promote stable training and better generalization. The attention map 318 may be visualized as a heatmap overlay on the input image, providing interpretability regarding which regions are being prioritized for restoration.

Convolution layers within the transformative filtering network may process input images by sliding a set of learnable filters, or kernels, across the spatial dimensions of the image to compute feature maps. Each filter may be designed to extract specific local patterns such as edges, corners, or textures by performing an element-wise multiplication between the filter weights and the local region of the image, followed by summing the results to produce a single output value. Multiple filters may be used in parallel to generate a stack of feature maps that capture different aspects of the input image. For example, early convolution layers may detect simple features like horizontal or vertical lines, while deeper layers may learn to identify more complex patterns such as shapes, objects, or localized regions affected by glare or stains. The stride and padding parameters of the convolution layers may be adjusted to control the spatial resolution and receptive field of the output feature maps. In some cases, dilated convolutions may be used to expand the effective receptive field without increasing the number of parameters, allowing the model to capture broader contextual information. Additionally, convolution layers may be applied in both the generator 312 and the discriminator 314 to transform and analyze images at various stages of processing.

ReLU layers, or Rectified Linear Unit layers, may introduce non-linearity into the model by applying an activation function to each element of the input feature map. The ReLU activation function outputs the input value if it is positive and zero otherwise, which may help the model learn complex, non-linear relationships between input and output data. By applying this operation after each convolution, the network may efficiently model the intricate variations present in real-world images, such as those caused by non-uniform stains, shadows, or lighting artifacts. For example, ReLU layers may enhance the ability of the network to distinguish between dark and bright regions in nighttime images or to preserve salient features during the restoration process. ReLU layers may also contribute to faster training convergence and may help mitigate the vanishing gradient problem that can occur in deeper networks.

LSTM components, or Long Short-Term Memory networks, may be incorporated within the attention blocks 319 to process sequential or spatial information in the feature maps. LSTM networks may use a system of gates (e.g., input, forget, and output gates) to regulate the flow of information, allowing the model to retain important features over multiple processing steps and to selectively update or discard irrelevant information. For example, LSTM components may iteratively refine the attention map 318 by focusing on regions of the image that exhibit the greatest degradation, such as areas obscured by stains or glare. By maintaining a memory of previous attention states, the LSTM may help the model adaptively concentrate on the most challenging portions of the image, leading to more effective restoration. For example, the LSTM may track the progression of stain removal across several iterations, gradually improving the clarity of the targeted regions.

Residual blocks 331 within the attention blocks 319 may facilitate the learning of complex mappings by allowing the model to learn residual functions, or differences, between the input and desired output. Each residual block may include one or more convolution layers and ReLU layers, as well as a shortcut connection that adds the input of the block directly to its output. This design may help mitigate the problem of vanishing gradients in deep networks and may promote the learning of fine-grained corrections rather than attempting to reconstruct the entire image from scratch. For example, a residual block may focus on removing localized artifacts introduced by dust particles or correcting subtle distortions in brightness caused by headlight glare, while preserving the underlying scene structure. In some implementations, residual blocks may be stacked to allow the model to address increasingly complex restoration challenges at different layers of abstraction.

Attention blocks 319 may coordinate the actions of the other components by generating spatially varying attention maps that highlight regions of interest in the input image. The attention map 318 produced by the attention block may assign higher weights to areas that are more severely degraded and lower weights to regions that require little or no correction. This selective focus may be achieved by combining the outputs of the LSTM, residual blocks, and convolution layers, followed by normalization and thresholding operations. The resulting attention map may be applied to the feature maps or directly to the input image to guide subsequent processing steps. For example, the attention block 319 may direct the model's resources toward removing a prominent stain in the center of the image while minimizing unnecessary changes to background regions that remain unaffected. The attention mechanism may improve both the efficiency and accuracy of the restoration process by ensuring that computational effort is concentrated where it is most needed.

The discriminator 314 may also rely on convolution and ReLU layers to assess the authenticity of the second image 309 produced by the generator 312. By analyzing local and global patterns in the restored image, the discriminator may determine whether the output resembles a real, clean image or retains artifacts indicative of incomplete restoration. The feedback from the discriminator 314 may be used to update the generator 312 during training, encouraging the model to produce images that are increasingly difficult for the discriminator to distinguish from genuine, uncorrupted examples. This adversarial interplay between the generator and discriminator may contribute to the progressive improvement of the transformative filtering network in restoring images affected by a wide variety of lens contaminations.

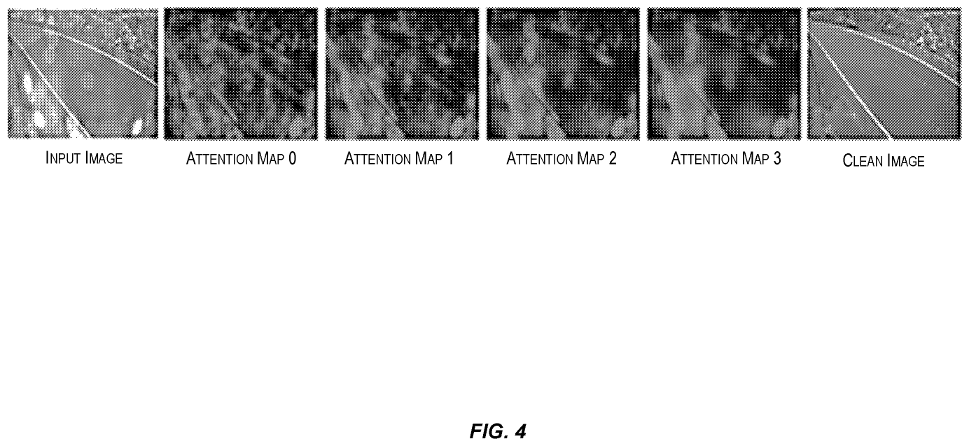

FIG. 4 depicts example attention maps generated by illustrative generators, according to various embodiments. By way of a non-limiting example, FIG. 4 depicts refinement of attention maps (e.g., as performed by attention block 319 with respect to FIG. 3) in an image restoration process, where each attention map becomes progressively clearer, increasingly concentrating on the stained areas. In the attention block, a gating system inspired by LSTM (e.g., LSTM 332 with respect to FIG. 3) is used to manage the flow of information and generate attention maps. Similar to LSTM, the system employs four gates: input (it), forget (ft), modulation (gt), and output (ot). These gates are defined as follows:

iₜ=σ(Wᵢᵢxₜ+Wₕᵢhₜ₋₁+bᵢ)

fₜ=σ(W_{if}xₜ+W_{hf}hₜ₋₁+b_{f})

gₜ=tan h(W_{ig}xₜ+W_{hg}hₜ₋₁+b_{g})

oₜ=σ(Wᵢₒxₜ+Wₕₒhₜ₋₁+bₒ)

where xₜ represents the input features at time t, including the degraded image features and the current attention map, and hₜ₋₁ is the hidden state from the previous timestep, representing the updated attention map. The weights (W) and biases (b) define the convolution operations applied within the gating system. At each iteration, the network dynamically adjusts attention regions based on the current input features and historical states (hₜ₋₁ and cₜ₋₁), progressively refining its focus on stain-affected areas. The cell state (cₜ) and hidden state (hₜ) are updated as follows:

cₜ=fₜ·cₜ₋₁+iₜ·gₜ

hₜ=oₜ·tan h(cₜ).

The generated attention maps may then be fed into convolutional layers to reconstruct the stained areas while preserving spatial resolution.

The discriminator may use a series of convolutional layers (as described with respect to FIG. 3) to extract and analyze features from the input images. The operation of these convolutional layers can be mathematically represented as:

xᵢ₊₁=ReLU(Conv(xᵢ,Wᵢ)+bᵢ)

for i=1, 2, 3, . . . , where xi is the input feature map at layer i, and Wᵢ, bᵢ are the corresponding weights and biases.

To effectively evaluate generated images, the discriminator must capture both global and stain-affected features, identifying synthetic artifacts and subtle restoration errors. A focused mechanism may be used that generates a mask via:

mask=Conv(xᵢ,Wₘₐₛₖ)+bₘₐₛₖ

which may be subsequently applied to the feature maps through element-wise multiplication to emphasize these regions. This differs from the attention map utilized in the generator (e.g., generator 312 with respect to FIG. 3), which guides the restoration process. In the discriminator (e.g., discriminator 314 with respect to FIG. 3), the mask may be further refined by incorporating the generator's attention map into the loss calculation. This integration ensures a coherent focus on regions and enhances the model's ability to detect inconsistencies between the restored and ground-truth images.

During training, paired images with and without stains are utilized ensuring both share the same background scene to guide the generator. The generator is trained with a composite loss function combining attention, reconstruction, and adversarial losses, ensuring it accurately targets stain-affected regions, restores the image to its clean state, and produces realistic outputs. The attention loss ensures the network correctly highlights stained regions:

$${L}_{att} = {\sum }_{i = 0}^{N - 1} {Θ}^{N - 1 - i} MSE ( {M}_{binary} , {M}_{i} )$$

where θ is a decay factor, M_{binary} is a binary mask obtained by thresholding the difference I_{clean}−Iₛₜₐᵢₙ, Mᵢ is the attention map at iteration i, and N is the total number of iterations. The decay factor emphasizes earlier iterations, allowing the network to progressively refine the attention maps. The reconstruction loss measures the difference between the restored image and the original clean image:

L_{rec}=MSE(I_{clean},I\hat{ }_{clean})

where I_{clean} is the ground-truth clean image and I\hat{ }_{clean} is the generator's output. To encourage the generator to produce realistic images that the discriminator classifies as real, an adversarial loss based on binary cross-entropy (BCE) is incorporated:

L_{gadv}=BCE(D(G(Iₛₜₐᵢₙ)),1)

where G is the generator, D is the discriminator, and Iₛₜₐᵢₙ is the input.

The overall loss for the generator is a weighted sum of these components:

L_{g}=γ₁·L_{gadv}+Lₐₜₜ+L_{rec}

where γ1 is a weighting factor that balances the adversarial loss against the attention and reconstruction losses.

The discriminator distinguishes real clean images from generated ones using adversarial loss and mask consistency loss. The adversarial loss enforces correct classification:

L_{dadv}=BCE(D(I_{clean}),1)+BCE(D(G(Iₛₜₐᵢₙ)),0)

The mask consistency loss ensures alignment between the discriminator's internal focus and the generator's attention map:

Lₘₐₚ=MSE(Dₘₐₛₖ(G(Iₛₜₐᵢₙ)),MG)+MSE(Dₘₐₛₖ(I_{clean}),0),

where Dₘₐₛₖ is the discriminator's mask output and MG is the generator's attention map. The overall loss for the discriminator is given by:

Ld=L_{dadv}+γ₂·Lₘₐₚ

where γ2 is a weighting factor that determines the relative importance of the mask consistency loss.

After dataset construction, an attention-based GAN model may be trained to restore stained images. A first step may include formalizing image degradation mathematically, modeling the observed image as a combination of a clean background, a binary stain mask, and a residual component capturing complex stain effects. The GAN framework consists of a generator and a discriminator. The generator, incorporating an attention block and an encoder-decoder network, refines attention maps to restore stained regions while preserving clean areas. The discriminator leverages convolutional feature extraction and mask-based assessment to evaluate both global realism and local consistency. A composite loss function combining attention, reconstruction, and adversarial losses guides training, ensuring the restored images closely approximate the ground truth. The following sections detail these components.

In some embodiments, the observed image I, degraded by stains adhering to the camera lens, may be modeled as:

I=(1−M)·B+R

where I denotes the degraded image, B is the clean background image, and M is a binary mask such that M(x)=1 indicates stain-affected pixels, while M(x)=0 represents unaffected pixels. The residual term R captures complex interactions (e.g., such as scattering and light diffusion) that further obscure background details. The operator · denotes element-wise multiplication, masking the clean background where stains are present and incorporating residual effects. Estimating the clean image B is challenging due to the difficulty in accurately computing both R and the binary mask M. To address this, a Generative Adversarial Network (GAN) with an attention mechanism to detect and restore stained regions while preserving unaffected areas may be implemented.

In some embodiments, for model training, pairs of images (e.g., 8000 images) may be generated featuring various background scenes and distributions of stains, as outlined in this dataset generation process. The dataset is categorized into synthetic and realistic simulation subsets. Specifically, the dataset includes synthetic image pairs (e.g., 6,000) and simulated real-world image pairs (e.g., 2,000). The model training may be conducted using a GPU (e.g., NVIDIA A6000). Systematic experiments in two different types of real-world locations were conducted, a highway and a rural roadway to comprehensively evaluate the effectiveness of the image restoration and detection framework under nighttime surveillance conditions. Specifically, images may be collected from these two types of locations under challenging conditions, primarily focusing on nighttime scenarios involving dust accumulation on the lens and interference from vehicle headlights.

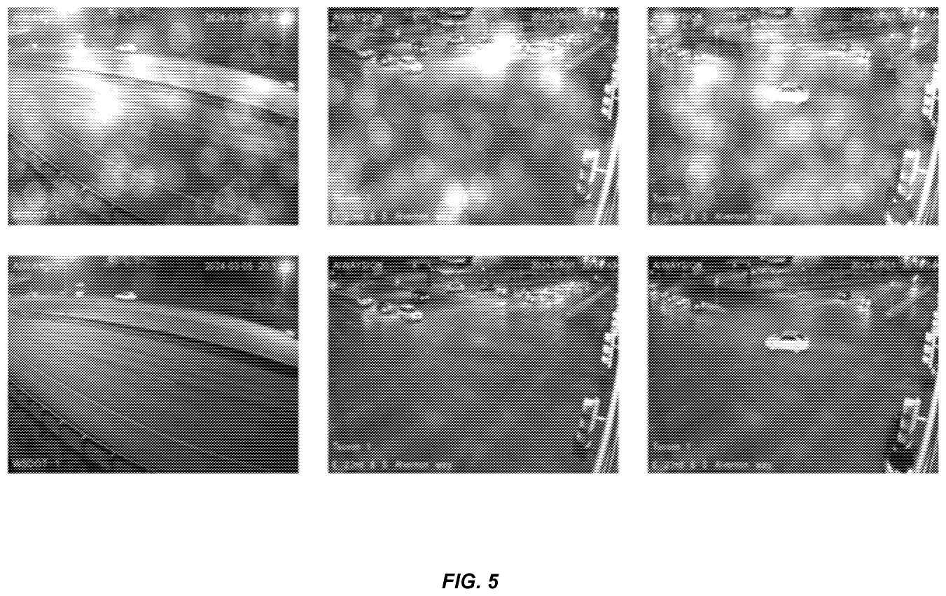

FIG. 5 depicts example images degraded with stains and light variation and corresponding ground truth images, according to various embodiments. A computer system (e.g., computer system 200 with respect to FIG. 2) may be scaled or adapted by adjusting parameters a, B, N or introducing new stain shapes and blob distributions, as described with respect to FIG. 2. The flexibility allows the dataset to be extended for broader examples to support more training of image restoration and detection algorithms under diverse conditions.

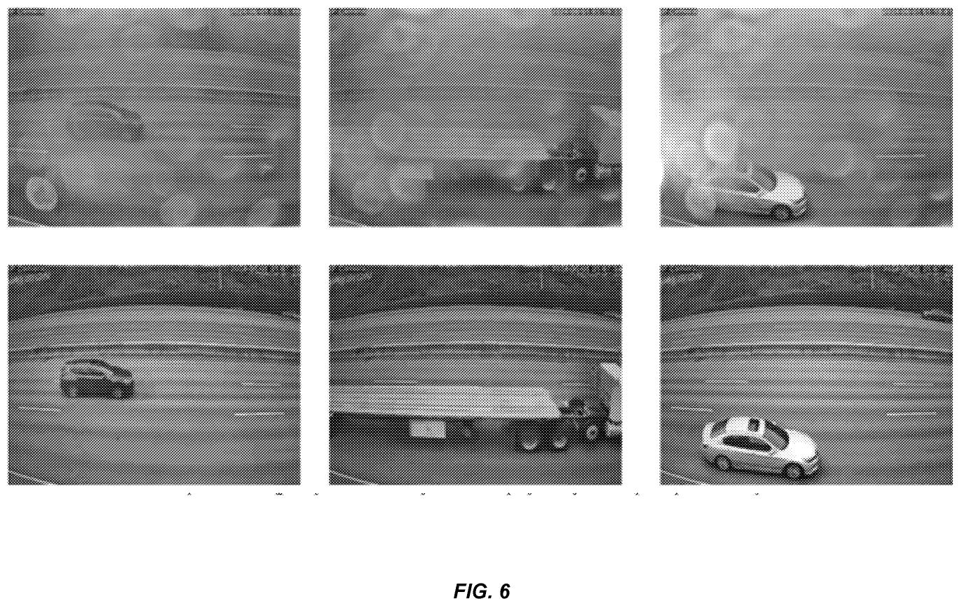

FIG. 6 depicts example samples of the simulated real-world images degraded by stains and light variation and correspond ground-truth images, according to various embodiments. The top row illustrates images visibly degraded by stains and light variations, while the bottom row shows clean counterparts. By providing pairs of aligned stained and unstained images, this real-world simulation dataset complements the synthetic dataset, facilitating training and validation under diverse conditions. These image pairs may be obtained through experimental procedures and system configurations described in FIGS. 2 and 3, including the application of contaminants to transparent films and the systematic capture of aligned clean and degraded images. The methods for generating, processing, and aligning the simulated real-world image pairs are consistent with the data acquisition and training with respect to FIGS. 2 and 3. By providing pairs of aligned stained and unstained images, this real-world simulation dataset complements the synthetic dataset, facilitating training and validation under diverse conditions.

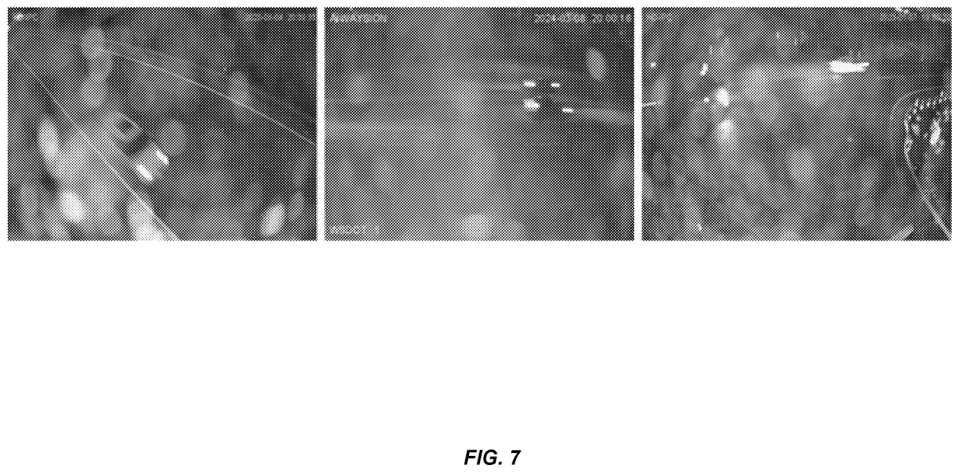

FIG. 7 depicts example nighttime images including illustrative degradations, according to various embodiments. By way of a non-limiting example, FIG. 7 illustrates examples of nighttime images collected from a real-world test set, which may include scenes captured in environments such as highways or rural roadways under conditions involving dust accumulation on the lens and varying nighttime illumination. These images may reflect the types of degraded inputs that are processed in the computer system described with respect to FIGS. 2 and 3. For example, the acquisition and use of such real-world images for evaluation or validation may be directly supported by the hybrid dataset construction methods and image restoration models discussed in connection with FIGS. 2 and 3. The images shown in FIG. 7 may be used as input to the transformative filtering network of FIG. 3, which may have been trained using the hybrid dataset generation and system architecture referenced in FIG. 2. This correlation allows for the assessment of how well the described restoration and detection methods perform under realistic nighttime surveillance conditions, as represented in the test samples of FIG. 7.

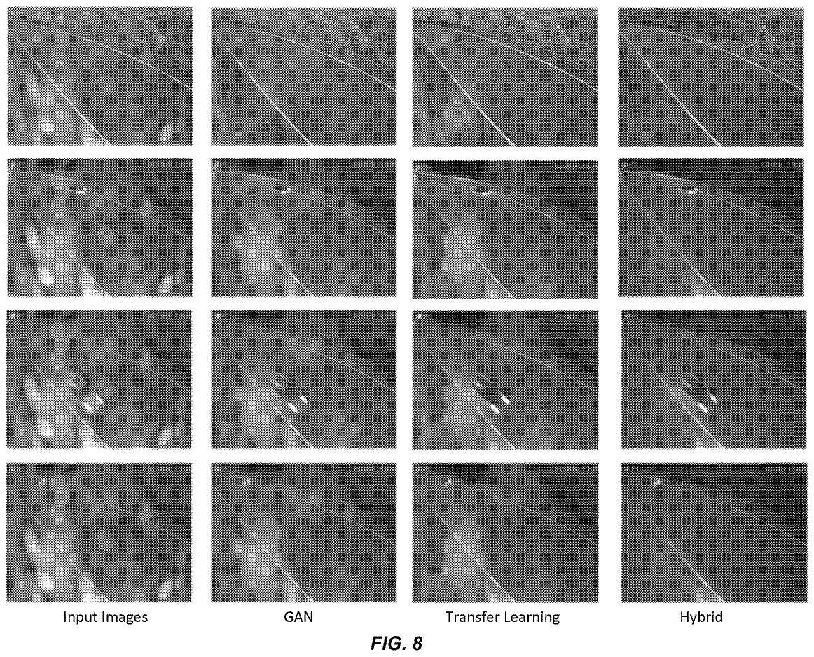

FIG. 8 depicts a grid of example images demonstrating differences in model methods based on a series of input images, according to various embodiments. For example, FIG. 8 depicts a qualitative comparison of different image restoration methods, showing, from left to right, original dust-impaired images as input, images processed using a GAN, images processed using a transfer learning model, and images processed using the proposed method described in this disclosure. The images depicted in FIG. 8 may be generated by applying the systems and processes detailed in FIGS. 2 and 3. For example, FIG. 2 describes how a hybrid dataset including both synthetic and simulated real-world images may be constructed and used for training. FIG. 3 details how a transformative filtering network with attention mechanisms may be trained and applied to restore degraded images. The restored images shown in FIG. 8, particularly those produced using the disclosed method, may demonstrate improved clarity, detail recovery, and feature preservation compared to the other methods, reflecting the impact of the hybrid dataset and model architecture described with respect to FIGS. 2 and 3. This comparison highlights the potential performance differences that may result from training and processing pipelines utilizing the dataset construction and model components referenced earlier.

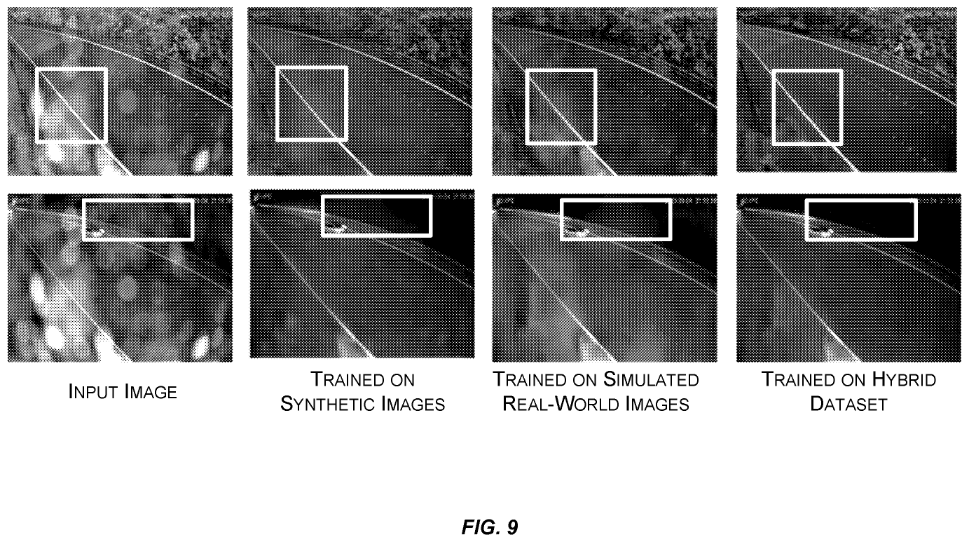

FIG. 9 depicts an example comparison of restoration results for models trained on a synthetic dataset, a real-world simulation dataset, and hybrid datasets, according to various embodiments. By way of a non-limiting example, FIG. 9 provides a comparison of restoration results generated by models trained on three different datasets: the synthetic dataset, the real-world simulation dataset, and a combined dataset that integrates both types. In these images, overlay boxes are used to highlight regions where detailed comparison of restoration quality is most instructive. The models used to generate these images and overlays may correspond to those described with respect to FIG. 2 or 3, where the training process may utilize the hybrid datasets discussed in connection with FIG. 2. By using either synthetic data, real-world simulated data, or a combination of both as outlined in FIGS. 2 and 3, the models may exhibit varying performance in addressing different patterns of degradation. The comparison in FIG. 9 demonstrates how the training data composition may influence the transformative filtering network's ability to restore fine details and handle diverse nighttime contamination scenarios.

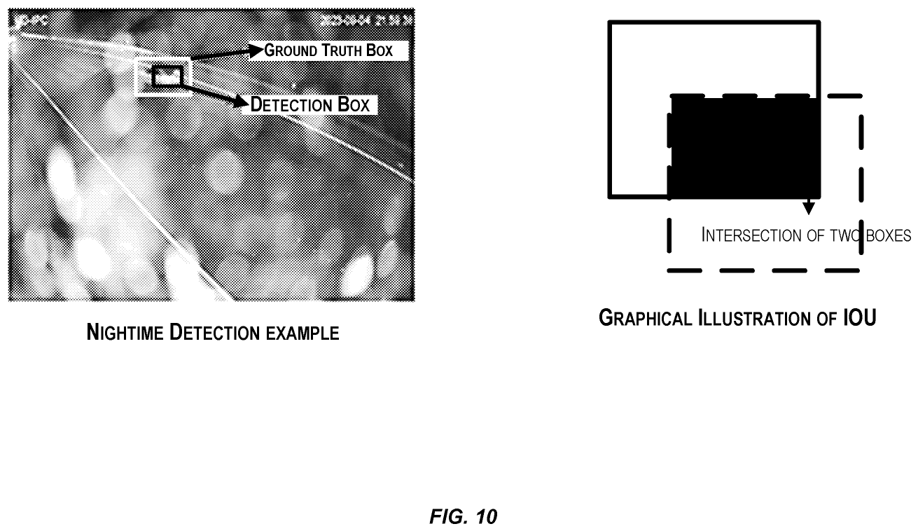

FIG. 10 depicts an example nighttime traffic scene detected by a model showing both ground truth and detection bounding boxes including an intersection area, according to various embodiments. By way of a non-limiting example, FIG. 10 depicts an illustration of the Intersection over Union (IoU) calculation and its application within the context of object detection in nighttime traffic scenes. In this figure, the left image may display a nighttime scene in which a detection model (e.g., a YOLOv8-based model as described in connection with FIGS. 2 and 3) has identified objects such as vehicles, with ground truth bounding boxes and predicted detection bounding boxes. The right image may visually represent the overlap, or intersection, between these bounding boxes, illustrating the area of agreement relative to the total area covered by both boxes. This visual representation may correspond to the evaluation metrics used to quantify the accuracy of the detection results produced by the system described in FIGS. 2 and 3, and highlights how restored images generated by the transformative filtering network may contribute to improved localization and detection performance in real-world nighttime conditions.

Regarding bounding boxes for object detection, overlap may occur in a variety of situations, each reflecting different operational and environmental factors. Overlap between bounding boxes may be observed between predicted detection boxes and ground truth boxes, between multiple predicted boxes, or even between ground truth boxes themselves in complex scenes. The IoU metric, which quantifies the area of intersection divided by the area of union for two bounding boxes, may serve as a primary indicator of detection accuracy and localization performance. In traffic surveillance applications, for example, bounding boxes representing vehicles may partially overlap when vehicles are closely spaced, partially occluded, or captured at oblique angles. This overlap may affect the confidence with which objects are detected, especially in low-visibility or heavily degraded images.

The frequency with which overlaps are updated may depend on the frame rate of the image capture system, the operational mode of the detection algorithm, and the rate at which scene content changes. In real-time applications such as highway monitoring, bounding box overlaps may be recalculated for each frame, which may range from several times per second to once every few seconds depending on system constraints. In datasets used for training or evaluation, overlaps may be computed each time a detection model processes an image or whenever ground truth annotations are revised. The process of updating overlaps may be influenced by changes in environmental conditions, such as the accumulation or removal of lens contaminants, variations in lighting, or the movement of objects within the scene.

The typical size of bounding boxes and their overlaps may vary widely depending on the scale of the scene, the distance of the camera to the objects, and the resolution of the imaging sensor. For scenes involving vehicles, bounding boxes may range from small (e.g., motorcycles or distant vehicles) to large (e.g., trucks or vehicles close to the camera). The absolute size of the intersection region may also depend on the accuracy of the detection model and the level of visual degradation present in the image. In some cases, the intersection may be substantial, such as when the predicted box closely matches the ground truth box, resulting in a high IoU value (e.g., greater than 0.7). In other cases, the intersection may be minimal, reflecting poor localization or the presence of multiple overlapping objects, leading to a lower IoU value.

The magnitude and frequency of overlaps may also be influenced by the density and arrangement of objects within a scene. In high-traffic environments or densely populated scenes, bounding boxes may overlap more frequently and to a greater extent, necessitating more sophisticated algorithms for distinguishing individual objects. The proportion of the intersection relative to the union may fluctuate as objects move relative to the camera or each other, or as the detection model adapts to changes in visual clarity following image restoration. For example, after applying an image restoration process, bounding box overlaps may be more accurately aligned with ground truth, resulting in larger intersection regions and improved IoU scores. In addition, or alternatively, in severely degraded images, predicted boxes may be misaligned or fragmented, reducing the intersection area and increasing the likelihood of false positives or negatives.

The intersection characteristics may also be a diagnostic tool for evaluating model performance across different environmental conditions and restoration stages. Consistent, large intersections may indicate effective detection and accurate localization, while frequent small or partial overlaps may signal persistent challenges in discriminating between objects or compensating for residual visual impairments. By systematically tracking the size, frequency, and distribution of bounding box overlaps, it is possible to monitor the ongoing effectiveness of both the detection and restoration components in a variety of operational scenarios, including those characterized by rapidly changing traffic patterns, variable lighting, and diverse forms of lens contamination.

The proportion of predicted bounding boxes (e.g., bounding box overlay) that correctly identify objects. Higher precision means fewer false positives. Recall: The proportion of actual objects correctly detected. Higher recall reduces missed detections. mAP50: Mean Average Precision measured at a single IoU threshold of 50%, reflecting the model's ability to identify objects without precise localization. mAP50-95: Mean Average Precision computed at Intersection over Union (IoU) thresholds ranging from 50% to 95%, providing a comprehensive measure of detection accuracy. Intersection over Union (IoU): Measures the overlap between predicted and ground truth bounding boxes. As shown in FIG. 10, IoU is defined as:

$$IoU = \frac{Area of Intersection}{Area of Union}$$

where the Area of Intersection is the overlapping region, and the Area of Union is the total area covered by both boxes, counting overlap only once. Higher IoU values indicate better localization accuracy, directly impacting mAP scores.

Comparing the detection performance before and after image restoration, the extent can be quantified to which this method benefits vehicle detection in dust-impaired nighttime scenes. Table I illustrates that this restoration process may enhance, in some embodiments, YOLOv8's detection metrics.

| Condition | mAP@50 | mAP@50-95 | Precision | Recall |
|---|---|---|---|---|
| Before Restoration | 81.0% | 41.5% | 87.8% | 69.4% |
| After Restoration | 85.0% | 42.8% | 94.2% | 77.6% |

Nevertheless, image restoration further boosted its capabilities. Specifically, mAP@50 rose from 81.0% to 85.0%, and mAP@50-95 improved from 41.5% to 42.8%. Additionally, precision increased from 87.8% to 94.2% (a 6.4% gain) and recall from 69.4% to 77.6% (an 8.2% improvement), highlighting enhanced accuracy in both detection and localization.

The gains can be attributed to the restoration of key visual details such as edges and contours previously obscured by dust. Improved visibility allows the detector to focus on salient features, thus increasing recall and enhancing localization precision. These improvements are important for real-time traffic surveillance and autonomous driving systems, where accurate vehicle detection ensures situational awareness and safety. By boosting detection accuracy without requiring specialized data or additional hardware, the restoration method offers a practical solution for vision-based applications in adverse conditions

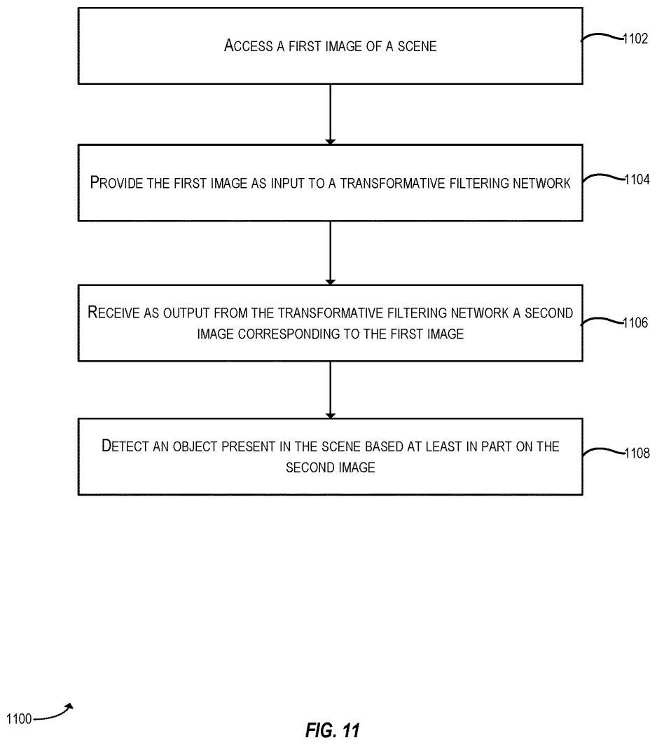

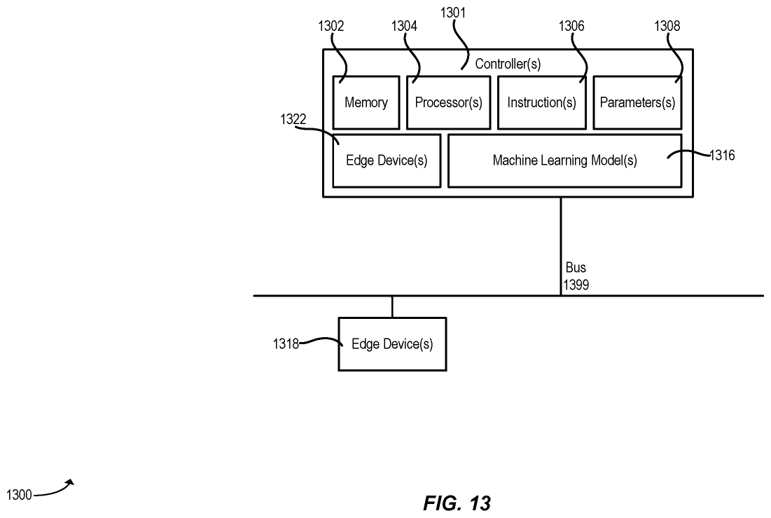

FIG. 11 is a simplified diagram of an example method 1100 for detecting an object in a scene using a transformative filtering network, according to some embodiments. In some embodiments, the method 1100 may include more or fewer steps than the number depicted in FIG. 11. It should be appreciated that the steps of the method 1100 may be performed in any suitable order. The method 1100 may be performed by some or all components of systems, devices, and/or include the processes, methods, or techniques as those described in relation to FIGS. 1-10. For example, the method 1100 may be implemented using the computer system 200 as illustrated in FIG. 2, which integrates dataset construction, image restoration using a transformative filtering network, and downstream object detection. The method 1100 may be performed by the computer architecture of FIG. 13.

At block 1102, the method 1100 may include the step of accessing a first image (e.g., first image 308 with respect to FIG. 3) of a scene. The step may be performed by a computer, an edge device, a transformative filtering network, a controller thereof, or any suitable processing system. In a non-limiting example, the first image may be a captured image by a camera (e.g., camera 220 with respect to FIG. 2) of a traffic scene. The first image may include a first level of degradation corresponding to a condition present when the first image was captured. The condition comprises one or more of: i) a blur, ii) a distortion, iii) an object which obscures a portion of the image, iv) a fog, v) rain droplets, vi) a reflection, vii) a glare, viii) dust, ix) snow, x) a stain, xi) dirt, xii) an animal, or any combination of two or more of i)-xii). The first level of degradation includes a clarity metric of the first image. The clarity metric may include a percentage (e.g., eighty percent blurred) of the first image which is distorted (e.g., blurred) by the present condition. For example, in a warehouse security setting, the first image could be a frame captured during a foggy night, where the degradation includes both atmospheric haze and water droplets on the protective lens cover.

At block 1104, the method 1100 may include the step of providing the first image may be provided as input to a transformative filtering network (e.g., transformative filtering network 210 with respect to FIG. 2). The step may be performed by a computer, an edge device, a transformative filtering network, a controller thereof, or any suitable processing system. The transformative filtering network may be a model associated with image processing (e.g., a GAN model as implemented in FIGS. 2 and 3). The first image may include a real-world scene such as, without limitation, a traffic scene including vehicles (e.g., cars), a city including structures (e.g., buildings), or suitable equivalents. The transformative filtering network may have been trained by using a hybrid dataset (e.g., hybrid dataset in training database 205 with respect to FIG. 2). The hybrid dataset may be generated by at least accessing a first set of synthetic images including one or more artificially created degradations that simulate degradations of a real-world environment, accessing a second set of simulated real-world images comprising one or more naturally generated degradations that are generated by the real-world environment, and generating a hybrid dataset by combining the first set of synthetic images with the second set of simulated real-world images. The first set of images may correspond to the second set of images. In some examples, the first set of synthetic images may be generated by using Gaussian distributions to simulate an interaction of vehicle headlights with a set of degradations. In some examples, the second set of simulated real-world images may be generated by applying a thin transparent film to a camera lens and spraying the thin transparent film with dust or water droplets in a low ambient light environment. This process allows the transformative filtering network to learn from both controlled, repeatable synthetic conditions and highly variable, realistic contamination scenarios, thereby improving generalizability.

At block 1106, the method 1100 may include the step of receiving a second image (e.g., second image 309 with respect to FIG. 3) as output from the transformative filtering network corresponding to the first image. The step may be performed by a computer, an edge device, a transformative filtering network, a controller thereof, or any suitable processing system. The second image may have a second level of degradation (e.g., how much contaminant or how distorted the image is). In some examples, the second level of degradation includes a second clarity metric of the second image, where the second clarity metric may include a second percentage (e.g., five percent blurred) of the second image which is distorted by the present condition, the first percentage being greater than the second percentage. In some examples, the first level or second level of degradation may be non-uniform or uniform. In some examples, the first level or second level of degradation may be at least partially transparent. For instance, in a port surveillance use case, the output second image may show significantly improved visibility of shipping containers after removing glare and dust artifacts, facilitating automated inventory tracking.

At block 1108, the method 1100 may include the step of detecting an object present in the scene based at least in part on the second image. The step may be performed by a computer, an edge device, a transformative filtering network, a controller thereof, or any suitable processing system. For example, the object may be a vehicle traveling at night in the rain. In this example, images captured at an edge device (e.g., a camera local to the vehicle) which were provided as input into the transformative filtering network at block 1102 may be undistorted (e.g., rain drops removed) and the object may be detected accurately. In an industrial plant setting, this could enable the system to detect personnel or machinery even when the camera's protective shield is partially obscured by oil residue, ensuring worker safety and operational oversight.

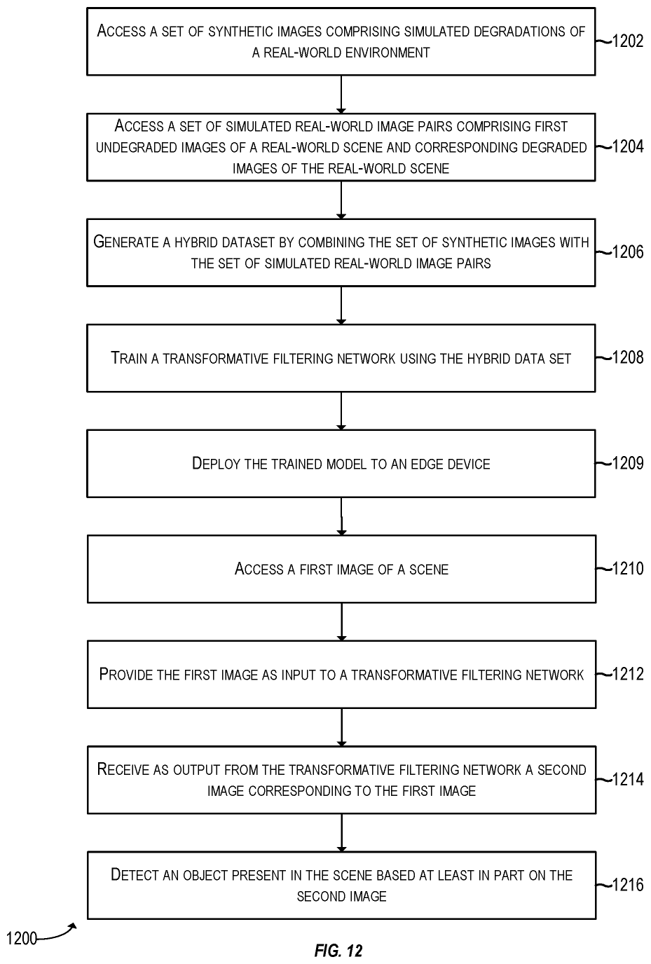

FIG. 12 is a simplified diagram of an example method 1200 for detecting an object in a scene using a transformative filtering network trained with a hybrid dataset, according to some embodiments. In some embodiments, the method 1200 may include more or fewer steps than the number depicted in FIG. 12. It should be appreciated that the steps of the method 1200 may be performed in any suitable order. The method 1200 may be performed by some or all components of systems, devices, and/or include the processes, methods, or techniques as those described in relation to FIGS. 1-11. For example, the method 1200 may be implemented using the computer system 200 as illustrated in FIG. 2, which integrates dataset construction, image restoration using a transformative filtering network, and downstream object detection. The method 1200 may be performed by the computer architecture of FIG. 12, the transformative filtering network described herein, an edge device (e.g., a camera surveillance system), combinations thereof, or any suitable equivalent.

At block 1202, the method 1200 may include the step of accessing a set of synthetic images comprising simulated degradations of a real-world environment. The step may be performed by a computer, an edge device, a transformative filtering network, a controller thereof, or any suitable processing system. By way of a non-limiting example, the set of synthetic images may be generated by applying transformations that simulate degradations of a real-world environment. The degradations may include effects such as stains, blurs, glare, or light scattering. For example, the method 1200 may include overlaying elliptical masks, Gaussian blobs, or procedural textures onto clean images to replicate the visual impact of dust, water droplets, or other contaminants commonly encountered in operational settings. Parameters for each synthetic degradation may be randomized to capture the diversity of contamination patterns and lighting conditions that may be present during image capture.

At block 1204, the method 1200 may include the step of accessing a set of simulated real-world image pairs comprising first undegraded images of a real-world scene and corresponding degraded images of the real-world scene. The step may be performed by a computer, an edge device, a transformative filtering network, a controller thereof, or any suitable processing system. By way of a non-limiting example, the image pairs may include first undegraded images of a real-world scene and corresponding degraded images of the same scene. The simulated real-world images may be acquired by physically introducing contaminants onto a transparent film or camera lens and capturing images before and after contamination. For example, dust, water droplets, or a combination of substances may be applied in varying concentrations and distributions, and images may be captured under different lighting conditions, including low-light or nighttime scenarios. The resulting image pairs may provide aligned examples of clean and contaminated scenes for use in training and evaluation.

At block 1206, the method 1200 may include the step of generating a hybrid dataset by combining the set of synthetic images with the set of simulated real-world image pairs. The step may be performed by a computer, an edge device, a transformative filtering network, a controller thereof, or any suitable processing system. By way of a non-limiting example, the synthetic and real-world images may be merged into a single dataset or used in alternating training batches. The hybrid dataset may support training by exposing a transformative filtering network to both controlled, repeatable degradations and the variability of realistic contamination scenarios. The structure of the dataset may include paired images, metadata describing the applied degradations, and any suitable environmental parameters recorded during image acquisition.

At block 1208, the method 1200 may include the step of training a transformative filtering network using the hybrid data set. The step may be performed by a computer, an edge device, a transformative filtering network, a controller thereof, or any suitable processing system. By way of a non-limiting example, the transformative filtering network may include a generator with attention mechanisms and a discriminator for evaluating image validity. The training process may utilize paired examples from the hybrid dataset to learn mappings from degraded to restored images. The network parameters may be iteratively updated using loss functions that account for attention, reconstruction, and adversarial objectives. The training may be conducted using computational resources such as a GPU, and the resulting model may be used for subsequent deployment in image restoration and object detection workflows.

At block 1209, the method 1200 may include a step corresponding to deploying the trained model to an edge device. The step may be performed by a computer, an edge device, a transformative filtering network, a controller thereof, or any suitable processing system. For example, the trained transformative filtering network, including model parameters, weights, configuration files, and execution instructions, may be packaged and transferred from the training environment, which may include a server or data center, to one or more edge devices (e.g., camera surveillance system). The edge device may be, without limitation, a smart camera, a traffic monitoring unit, a vehicle-mounted camera, or any computational unit with local processing capability located at or near the data source.

Deployment to the edge device may allow the transformative filtering network to operate locally where images are captured or initially received. The edge device may perform, for example, image restoration and object detection in real-time or near-real-time, which may reduce transmitting volumes of raw image data (e.g., gigabytes to terabytes per year) to servers and may help lower processing latency. The deployment process may be managed so that updates to the model or configuration may be pushed to the edge device as new training results become available or as operational requirements change.

At block 1210, a first image (e.g., first image 308 with respect to FIG. 3) of a scene may be accessed. The step may be performed by a computer, an edge device, a transformative filtering network, a controller thereof, or any suitable processing system. In a non-limiting example, the first image may be a captured image by a camera (e.g., camera 220 with respect to FIG. 2) of a traffic scene. The first image may include a first level of degradation corresponding to a condition present when the first image was captured. The condition comprises one or more of: i) a blur, ii) a distortion, iii) an object which obscures a portion of the image, iv) a fog, v) rain droplets, vi) a reflection, vii) a glare, viii) dust, ix) snow, x) a stain, xi) dirt, xii) an animal, or any combination of two or more of i)-xii). The first level of degradation includes a clarity metric of the first image. The clarity metric may include a percentage (e.g., eighty percent blurred) of the first image which is distorted (e.g., blurred) by the present condition. For example, in a warehouse security setting, the first image could be a frame captured during a foggy night, where the degradation includes both atmospheric haze and water droplets on the protective lens cover.

At block 1212, the first image may be provided as input to a transformative filtering network (e.g., transformative filtering network 210 with respect to FIG. 2). The step may be performed by a computer, an edge device, a transformative filtering network, a controller thereof, or any suitable processing system. The transformative filtering network may be a model associated with image processing (e.g., a GAN model as implemented in FIGS. 2 and 3). The first image may include a real-world scene such as, without limitation, a traffic scene including vehicles (e.g., cars), a city including structures (e.g., buildings), or suitable equivalents. The transformative filtering network may have been trained by using a hybrid dataset (e.g., hybrid dataset in training database 205 with respect to FIG. 2). The hybrid dataset may be generated by at least accessing a first set of synthetic images including one or more artificially created degradations that simulate degradations of a real-world environment, accessing a second set of simulated real-world images comprising one or more naturally generated degradations that are generated by the real-world environment, and generating a hybrid dataset by combining the first set of synthetic images with the second set of simulated real-world images. The first set of images may correspond to the second set of images. In some examples, the first set of synthetic images may be generated by using Gaussian distributions to simulate an interaction of vehicle headlights with a set of degradations. In some examples, the second set of simulated real-world images may be generated by applying a thin transparent film to a camera lens and spraying the thin transparent film with dust or water droplets in a low ambient light environment. This process allows the transformative filtering network to learn from both controlled, repeatable synthetic conditions and highly variable, realistic contamination scenarios, thereby improving generalizability.

At block 1214, a second image (e.g., second image 309 with respect to FIG. 3) may be received as output from the transformative filtering network corresponding to the first image. The step may be performed by a computer, an edge device, a transformative filtering network, a controller thereof, or any suitable processing system. The second image may have a second level of degradation (e.g., how much contaminant or how distorted the image is). In some examples, the second level of degradation includes a second clarity metric of the second image, where the second clarity metric may include a second percentage (e.g., five percent blurred) of the second image which is distorted by the present condition, the first percentage being greater than the second percentage. In some examples, the first level or second level of degradation may be non-uniform or uniform. In some examples, the first level or second level of degradation may be at least partially transparent. For instance, in a port surveillance use case, the output second image may show significantly improved visibility of shipping containers after removing glare and dust artifacts, facilitating automated inventory tracking.

At block 1216, an object present in the scene may be detected based at least in part on the second image. The step may be performed by a computer, an edge device, a transformative filtering network, a controller thereof, or any suitable processing system. For example, the object may be a vehicle traveling at night in the rain. In this example, images captured at an edge device (e.g., a camera local to the vehicle) which were provided as input into the transformative filtering network at block 1202 may be undistorted (e.g., rain drops removed) and the object may be detected accurately. In an industrial plant setting, this could enable the system to detect personnel or machinery even when the camera's protective shield is partially obscured by oil residue, ensuring worker safety and operational oversight.

As described previously, an edge device may perform the steps described in blocks 1202 through 1216, including, without limitation, accessing a first image of a scene, providing the image as input to the transformative filtering network, receiving a restored image with reduced degradation, and detecting an object present in the scene based at least in part on the restored image. The edge device may be the same device used for training and dataset construction or may be a different device that receives the trained model for inference. In some examples, multiple edge devices may be deployed throughout a network, with each device running the trained transformative filtering network locally to support low-latency image restoration and object detection. The edge device may handle additional functions, such as generating bounding box overlays, controlling traffic signals, adjusting camera parameters, or sending detection results to a central management system.

FIG. 13 depicts an example block diagram for an illustrative system architecture 1300 diagram for detecting objects present in scenes, according to various embodiments. FIG. 13 shows an example system architecture that may support the detection of objects in scenes, including those captured under degraded nighttime conditions described in earlier figures. The controllers 1301 may be constructed to coordinate various operations such as storing, processing, and transmitting data throughout the system. These controllers may include one or more memories 1302, which may store not only the instructions 1306 but also a range of parameters 1308. These parameters may relate to transformative filtering networks 1316, including details about model weights, training data, image samples, embeddings, and information from third-party models. The instructions 1306 may allow the system to execute tasks such as image restoration, object detection, or updating model parameters as new data is acquired or as environmental conditions shift.

The system architecture 1300 may directly interact with edge devices 1322, such as cameras positioned at traffic intersections, highways, or other surveillance points. In some implementations, these edge devices may operate independently, running subsets of the instructions 1306 locally for low-latency processing. For example, a camera system at a remote rural highway may capture images exhibiting various degradations described in FIGS. 1, 5, and 7, and transmit those images to the controllers 1301 for restoration and detection. In other cases, edge devices 1318 may be networked over bus 1399, allowing for distributed processing or centralized coordination depending on available bandwidth, system requirements, or the number of devices deployed in the field.

The connection between the controllers 1301 and edge devices 1322 or 1318 may be implemented using various protocols, including wired Ethernet, wireless radio, fiber optics, or other networking technologies appropriate for the deployment environment. For example, in urban settings with existing infrastructure, high-bandwidth wired connections may be feasible, whereas in temporary or mobile installations, wireless links may be preferred. The system may dynamically allocate tasks such as image pre-processing, restoration using the trained transformative filtering network 1316, and downstream object detection based on available computational resources. In some scenarios, only the initial degraded images may be sent to a remote server for full processing, while in others, partial restoration and detection may occur locally on the edge device, with only detection results or flagged events transmitted back to a central location.

The system architecture 1300 described in FIG. 13 may be configured to handle a range of use cases and data flows. For instance, during periods of high traffic or increased environmental contamination, the controllers 1301 may adapt by prioritizing real-time image restoration and detection tasks, while deferring less critical background processes such as periodic model retraining or bulk data archiving. The memories 1302 may store historical images, prior detection results, and metadata about environmental conditions, which may then inform adaptive adjustments to processing pipelines. This flexibility may allow the system to maintain consistent detection performance under variable conditions, such as those illustrated in the different types of degradations and restoration outcomes shown in FIGS. 5 through 9.

The computer architecture of FIG. 13 may support advanced workflows that integrate the methods and models described earlier. For example, a degraded image obtained at night (as described with respect to FIGS. 1 and 7) may be routed through the attention-guided restoration model, with restored outputs stored and further analyzed for object detection using a detection model such as YOLOv8. The results, such as bounding boxes and IoU scores as described with respect to FIG. 10, may be retained in the memories 1302 or transmitted to traffic management centers for further action. Over time, as new degradations are encountered, additional synthetic or real-world contaminated images may be incorporated into the system's training datasets, supporting periodic updates to the model parameters 1308 and instructions 1306.

The system of FIG. 13 may also facilitate integration with external sensors, data sources, or other monitoring equipment, providing a comprehensive platform for multi-modal traffic surveillance or security applications. For instance, metadata from weather sensors, road condition monitors, or incident reports may be linked with image data, providing context that supports improved detection accuracy or targeted maintenance scheduling. In summary, the architecture depicted in FIG. 13 may serve as a flexible and adaptable platform, connecting the various methods and data flows illustrated throughout the previous figures (e.g., FIGS. 1-12), and supporting the implementation of image restoration and object detection methods in diverse real-world settings.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure.

Specific elements of any foregoing embodiments can be combined or substituted for elements in other embodiments. Moreover, the inclusion of specific elements in at least some of these embodiments may be optional, wherein further embodiments may include one or more embodiments that specifically exclude one or more of these specific elements. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to” Words using the singular or plural number also include the plural and singular number, respectively. Additionally, the words “herein,” “above,” and “below” and words of similar import, when used in this application, shall refer to this application as a whole and not to any particular portions of the application.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present invention. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Ail numerical values, however, inherently contain a range necessarily resulting from the standard deviation found in their respective testing measurements.

All headings are for the convenience of the reader and should not be used to limit the meaning of the text that follows the heading, unless so specified.

It will be appreciated that, although specific embodiments of the invention have been described herein for purposes of illustration, various modifications may be made without deviating from the spirit and scope of the invention. Accordingly, the invention is not limited except as by the claims.

What is claimed is:

1. A computer-implemented method, comprising:
accessing a first image of a scene, wherein the first image comprises a first level of degradation corresponding to a condition present when the first image was captured;
providing the first image as input to a transformative filtering network;
receiving as output from the transformative filtering network a second image corresponding to the first image, wherein the second image comprises a second level of degradation that is less than the first level of degradation; and
detecting an object present in the scene based at least in part on the second image.

2. The computer-implemented method of claim 1, wherein the condition comprises one or more of: i) a blur, ii) a distortion, iii) an object which obscures a portion of the first image, iv) a fog, v) rain droplets, vi) a reflection, vii) a glare, viii) dust, ix) snow, x) a stain, xi) dirt, xii) an animal, or any combination of two or more of i)-xii).

3. The computer-implemented method of claim 1, wherein the first level of degradation includes a first clarity metric of the first image.

4. The computer-implemented method of claim 3, wherein the first clarity metric includes a first percentage of the first image which is distorted by a degradation.

5. The computer-implemented method of claim 4, wherein the second level of degradation includes a second clarity metric of the second image.

6. The computer-implemented method of claim 5, wherein the second clarity metric includes a second percentage of the second image which is distorted by a degradation, the first percentage being greater than the second percentage.

7. The computer-implemented method of claim 1, wherein the first level of degradation or the second level of degradation is non-uniform or uniform.

8. The computer-implemented method of claim 1, further comprising:
prior to accessing the first image:
accessing a set of synthetic images comprising simulated degradations of a real-world environment;
accessing a set of simulated real-world image pairs comprising first undegraded images of a real-world scene and corresponding degraded images of the real-world scene;
generating a hybrid dataset by combining the set of synthetic images with the set of simulated real-world image pairs; and
training the transformative filtering network using the hybrid data set.

9. The computer-implemented method of claim 8, wherein the set of synthetic images is generated by using Gaussian distributions to simulate an interaction of vehicle headlights with a set of degradations.

10. The computer-implemented method of claim 1, wherein providing the first image as input to the transformative filtering network further comprises:
executing the transformative filtering network on a device that shares a network with a camera that captured the first image.

11. The computer-implemented method of claim 1, wherein the first level of degradation or the second level of degradation is at least partially transparent.

12. The computer-implemented method of claim 1, wherein the first image is captured in a low light environment.

13. A system comprising:
a camera configured to capture images of a real-world scene;
a processor;
a memory coupled to the processor, the memory having instructions that when executed by the processor, cause the processor to perform operations, the operations comprising:
accessing a first image of a scene, wherein the first image comprises a first level of degradation corresponding to a condition present when the first image was captured;
providing the first image as input to a transformative filtering network;
receiving as output from the transformative filtering network a second image corresponding to the first image, wherein the second image comprises a second level of degradation that is less than the first level of degradation; and
detecting an object present in the scene based at least in part on the second image.

14. The system of claim 13, wherein the operations further comprise: controlling an operation of the camera based at least in part on detecting the object present in the scene.

15. The system of claim 13, wherein the operations further comprise: controlling an operation of a traffic system based at least in part on detecting the object present in the scene.

16. The system of claim 13, wherein the operations further comprise:
accessing a set of synthetic images comprising simulated degradations of a real-world environment;
accessing a set of simulated real-world image pairs comprising first undegraded images of a real-world scene and corresponding degraded images of the real-world scene;
generating a hybrid dataset by combining the set of synthetic images with the set 6 of simulated real-world image pairs; and
training the transformative filtering network using the hybrid data set.

17. A non-transitory computer readable medium having instructions that when executed by a processor, cause the processor to perform operations, the operations comprising:
accessing a set of synthetic images comprising simulated degradations of a real-world environment;
accessing a set of simulated real-world image pairs comprising first undegraded images of a real-world scene and corresponding degraded images of the real-world scene;
generating a hybrid dataset by combining the set of synthetic images with the set of simulated real-world image pairs; and
training a transformative filtering network using the hybrid data set.

18. The non-transitory computer readable medium of claim 17, wherein the transformative filtering network is a generative adversarial network (GAN).

19. The non-transitory computer readable medium of claim 17, wherein the operations further comprise:
deploying the transformative filtering network to an edge device configured to use the transformative filtering network detect an object present in a scene, and control an operation of a traffic system based at least in part on detecting the object present in the scene.

20. The non-transitory computer readable medium of claim 17, wherein the operations further comprise:
deploying the transformative filtering network to an edge device configured to use the transformative filtering network to reduce a level of degradation of an image of a scene, and detect an object present in the scene based at least in part on reducing the level of degradation of the image.
